(19) United States
(12) Patent Application Publication
(10) Pub. No.: US 2026/0237057 A1
(43) Pub. Date: Aug. 13, 2026

(54) METHODS AND SYSTEMS FOR ANOMALY DETECTION OF A CARRIER PLATE

(71) Applicant: ZHEJIANG HUARAY TECHNOLOGY CO., LTD., Hangzhou (CN)

(72) Inventors: Sensen LI, Hangzhou (CN); Yu LIU, Hangzhou (CN); Yanhui LIU, Hangzhou (CN); Jiafeng DONG, Hangzhou (CN); Ming LI, Hangzhou (CN)

(73) Assignee: ZHEJIANG HUARAY TECHNOLOGY CO., LTD., Hangzhou (CN)

(21) Appl. No.: 19/645,064

(22) Filed: Apr. 10, 2026

Related U.S. Application Data
(63) Continuation of application No. PCT/CN2024/101984, filed on Jun. 27, 2024.

(30) Foreign Application Priority Data
Oct. 11, 2023 (CN) 202311318080.0

(51) Int. Cl. G06T 7/00; G01S 17/89; G06T 7/11; G06T 7/60; G06T 7/73

(52) U.S. Cl. CPC G06T 7/001; G01S 17/89; G06T 7/11; G06T 7/60; G06T 7/73; G06T 2207/10028; G06T 2207/20081; G06T 2207/30164

(57) ABSTRACT

The present disclosure may provide a method and a system for anomaly detection of a carrier plate. The method may be implemented by the system for anomaly detection of a carrier plate including at least a processor and a storage device. The method may include: obtaining point cloud data of the carrier plate and a subject placed on the carrier plate; obtaining at least one data block by segmenting the point cloud data; and performing an anomaly detection of the carrier plate based on the at least one data block.

### CROSS-REFERENCE TO RELATED APPLICATIONS

This application is a Continuation of International Application No. PCT/CN2024/101984, filed on Jun. 27, 2024, which claims priority of Chinese Patent Application No. 202311318080.0, filed on Oct. 11, 2023, the entire contents of each of which are incorporated herein by reference.

### TECHNICAL FIELD

The present disclosure relates to the photovoltaic field s, and in particular to a method and a system for anomaly detection of a carrier plate.

### BACKGROUND

With the continuous development of science and technology, new energy technologies are used more and more widely. In the photovoltaic field, the processing and detection of photovoltaic silicon wafers are very important. Usually, a photovoltaic silicon wafer may need to be placed on a carrier plate for processing and detection. During the process of processing, the anomaly of the carrier plate (e.g., improper placement of the photovoltaic silicon wafer on the carrier) may seriously affect the subsequent processing flow, causing damage to the quality of the photovoltaic silicon wafer.

Therefore, it is desirable to provide a method and a system for anomaly detection of a carrier plate with improved efficiency and accuracy, thereby improving the process quality of the silicon wafer.

### SUMMARY

One or more embodiments of the present disclosure provide a method for anomaly detection of a carrier plate, implemented by a a system for anomaly detection of a carrier plate including at least a processor and a storage device comprising: obtaining point cloud data of the carrier plate and a subject placed on the carrier plate; obtaining at least one data block by segmenting the point cloud data; and performing an anomaly detection of the carrier plate based on the at least one data block.

One or more embodiments of the present disclosure provide a system for anomaly detection of a carrier plate, wherein a subject is placed on the carrier plate, comprising: at least one storage device including a set of instructions; and at least one processor in communication with the at least one storage device. When executing the set of instructions, the at least one processor may be directed to perform operations including: obtaining point cloud data of the carrier plate and a subject placed on the carrier plate; obtaining at least one data block by segmenting the point cloud data; and performing an anomaly detection of the carrier plate based on the at least one data block.

One of the embodiments of the present disclosure provides a system for anomaly detection of a carrier plate, wherein a subject is placed on the carrier plate, comprising: an acquisition module configured to obtain point cloud data of the carrier plate and a subject placed on the carrier plate; a processing module configured to obtain at least one data block by segmenting the point cloud data; and an abnormal detection module configured to perform an anomaly detection of the carrier plate based on the at least one data block.

One or more embodiments of the present disclosure provide a non-transitory computer readable medium, comprising at least one set of instructions. When executed by one or more processors of a computing device, the at least one set of instructions may cause the computing device to perform a method for evaluating a blood flow parameter, the method comprising: obtaining point cloud data of the carrier plate and a subject placed on the carrier plate; obtaining at least one data block by segmenting the point cloud data; and performing an anomaly detection of the carrier plate based on the at least one data block.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary system for anomaly detection of a carrier plate according to some embodiments of the present disclosure;

FIG. 2 is a schematic diagram illustrating exemplary hardware and software components of an exemplary computing device according to some embodiments of the present disclosure;

FIG. 3 is a block diagram illustrating an exemplary system for anomaly detection of a carrier plate according to some embodiments of the present disclosure;

FIG. 4 is a flowchart illustrating an exemplary process for anomaly detection of a carrier plate according to some embodiments of the present disclosure;

FIG. 5 is a flowchart illustrating an exemplary process of pre-processing according to some embodiments of the present disclosure;

FIG. 6 is a flowchart illustrating an exemplary process of correction according to some embodiments of the present disclosure;

FIG. 7 is a flowchart illustrating an exemplary process of anomaly detection of a carrier plate after matching positioning according to some embodiments of present disclosure;

FIG. 8 is a flowchart illustrating an exemplary process of anomaly detection of a carrier plate based on height information according to some embodiments of the present disclosure;

FIG. 9 is a flowchart illustrating another exemplary process of anomaly detection of a carrier plate based on height information according to some embodiments of the present disclosure;

FIG. 10 is a flowchart illustrating an exemplary process of anomaly detection of a carrier plate based on volume information according to some embodiments of the present disclosure;

FIG. 11 is a schematic diagram illustrating an exemplary process of anomaly detection of a carrier plate based on a first detection model according to some embodiments of the present disclosure;

FIG. 12 is a schematic diagram illustrating an exemplary process of anomaly detection of a carrier plate based on a second detection model according to some embodiments of the present disclosure;

FIG. 13 is a schematic diagram illustrating an exemplary process of anomaly detection of a carrier plate based on a first detection model and a second detection model according to some embodiments of the present disclosure;

FIG. 14 is a schematic structural diagram illustrating an exemplary carrier plate according to some embodiments of the present disclosure;

FIG. 15 is a schematic structural diagram illustrating another exemplary carrier plate according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

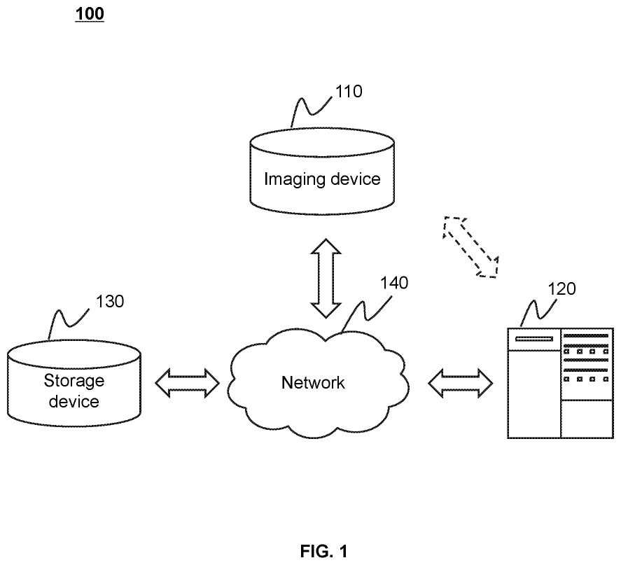

FIG. 1 is a schematic diagram illustrating an exemplary system for anomaly detection of a carrier plate according to some embodiments of the present disclosure.

As shown in FIG. 1, the system for anomaly detection of a carrier plate 100 (also referred to as anomaly detection system 100) involved in the embodiments of the present disclosure may include an imaging device 110, a processor 120, a storage device 130, and a network 140. In some embodiments, the anomaly detection system may be implemented by the method and/or process disclosed in the present disclosure.

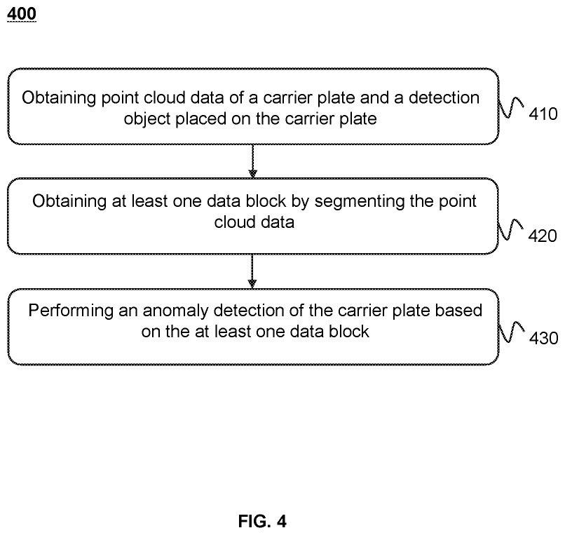

The imaging device 110 may be configured to obtain point cloud data of the carrier plate and a subject placed on the carrier plate. More descriptions regarding the subject may be found in the related descriptions of FIG. 4.

As used herein, the point cloud data may include a set of data points associated with an object (e.g., a silicon wafer and the carrier plate). Each of the data points of the point cloud data may represent or correspond to a physical point, or a portion, or a region of the object (e.g., the silicon wafer and the carrier plate).

In some embodiments, the point cloud data may include at least one eigenvalue of at least one feature of the physical points. Exemplary features of a physical point may include one of a location of the physical point, a category of the physical point, the lightness of the physical point, the color of the physical point, or the like, or any combination thereof. In some embodiments, the location of a physical point may include a geographic location of the physical point. For example, the location of the physical point may be expressed as a latitudes, a longitude, and/or altitudes in a geographic coordinate system. In some embodiments, the location of a physical point relative to a sensor (or object) may be expressed as coordinates of the physical point in a reference coordinate system associated with the sensor (or object). The reference coordinate system associated with the sensor (or object) may be any suitable coordinate system. An origin of the reference coordinate system may be located at the sensor (or object).

In some embodiments, the imaging device 110 may include a laser scanner (e.g., LiDAR (light detection and ranging)), a depth camera, a stereo camera, or the like. A laser scanner may record three-dimensional coordinates, reflectivity, textures and/or other information of a large number of dense points on a surface of the measured object based on the principle of laser ranging. The depth camera may be configured to project light with structural features onto the object through a near-infrared laser, and obtain depth information through an infrared sensor. The stereo camera may be configured to use two cameras to obtain two images of the object from different positions, and determine a position deviation of corresponding points in the two images that represents the same position or region on the object to determine the three-dimensional coordinates of the points based on the triangulation principle.

The processor 120 may be configured to process data and/or information obtained from the imaging device 110, the storage device 130, and/or other storage devices. For example, the processor 120 may obtain initial point cloud data of a subject from the imaging device 110 and/or the storage device 130. As another example, the processor 120 may obtain the point cloud data by pre-processing the initial point cloud data. As another example, the processor 120 may obtain at least one data block by segmenting the point cloud data; and perform an anomaly detection of the carrier plate based on the at least one data block.

In some embodiments, the processor 120 may be a single server or a server group. The server group may be centralized or distributed. In some embodiments, the processor 120 may be local or remote. For example, the processor 120 may access information and/or data from the storage device 130 via the network 140. As another example, the processor 120 may be directly connected to the network 140 and the storage device 130 to access information and/or data. In some embodiments, the processor 120 may be implemented on a cloud platform. For example, the cloud platform may include a private cloud, a public cloud, a hybrid cloud, a community cloud, a distributed cloud, an inter-cloud cloud, a multi-cloud, or the like, or any combination thereof.

In some embodiments, the processor 120 may be implemented on a computing device. The computing device may be a computer connected to the imaging device 110, such as a laptop or desktop computer placed in a scanning room or an operating room. In some embodiments, the imaging device 110 and/or other possible system components may include the processor 120. For example, the processor 120 or a module that can implement the functions of the processor 120 may be integrated into the imaging device 110 and/or other possible system components.

The storage device 130 may be configured to store data, instructions, and/or any other information. In some embodiments, the storage device 130 may store data obtained from the imaging device 110 and/or the processor 120. For example, the storage device 130 may be configured to store the point cloud data of the subject. In some embodiments, the storage device 130 may be configured to store data and/or instructions that the processor 120 uses to execute or use to complete the exemplary methods described in the present disclosure. For example, the storage device 130 may be configured to store instructions for controlling the processor to segment on the point cloud data.

In some embodiments, the storage device 130 may include a mass storage, a removable storage, a volatile read-write memory, a read-only memory (ROM), or the like, or any combination thereof. In some embodiments, the storage device 130 may be implemented on the cloud platform. In some embodiments, the storage device 130 may be a portion of the processor 120.

The network 140 may include any suitable network that facilitates information and/or data exchange. In some embodiments, one or more components of the application scenario 100 may exchange information and/or data via the network 140. For example, the processor 120 may be configured to obtain the point cloud data of the carrier plate and the subject placed on the carrier plate via the network 140. The network 140 may include a local area network (LAN), a wide area network (WAN), a wired network, a wireless network, or the like, or any combination thereof.

In some embodiments, the application scenario 100 may also include a terminal device (not shown in FIG. 1).

The terminal device refers to one or more terminal devices or software used by a user. In some embodiments, the processor 120 may send a processing result to the terminal device to display the processing result to the user. For example, the processor 120 may send at least one of the point cloud data of the subject and an anomaly detection result of the carrier plate to the terminal device.

In some embodiments, the terminal device may include a mobile device, a tablet computer, a laptop computer, a desktop computer, and other devices with input and/or output functions, or any combination thereof. In some embodiments, the user terminal may be used by one or more users, including users directly using the service or other related users. The above examples are only used to illustrate the wide range of the terminal device and are not intended to limit the scope of the terminal device.

It should be noted that the above description is provided for illustrative purposes only and is not intended to limit the scope of the present disclosure. For those of ordinary skill in the art, under the guidance of the contents of the present disclosure, various changes and modifications can be made. The features, structures, methods and other features of the exemplary embodiments described in the present disclosure can be combined in various ways to obtain additional and/or alternative exemplary embodiments. However, such changes and modifications will not deviate from the scope of the present disclosure.

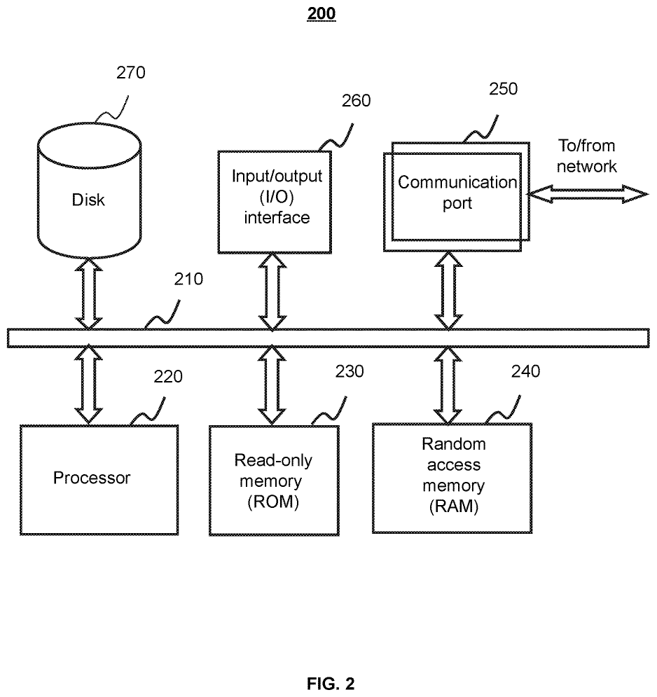

FIG. 2 is a schematic diagram illustrating exemplary hardware and software components of an exemplary computing device according to some embodiments of the present disclosure. A computing device 200 may be configured to perform one or more functions of at least one component of a system for evaluating a blood flow parameter disclosed in the embodiments of the present disclosure.

The computing device 200 may include a general-purpose computer or a special-purpose computer, both of which may be used to implement the method for evaluating the blood flow parameter described in some embodiments of the present disclosure. The computing device 200 may include any components for implementing the system for anomaly detection of a carrier plate as described in the present disclosure. For example, the processor may be implemented on the computing device 200 through hardware, software programs, firmware, or any combination thereof. For convenience, only one computer is shown in the figure, but the computer functions related to the anomaly detection of the carrier plate described in the present disclosure can be implemented in a distributed manner on multiple similar platforms for processing load distribution.

For example, the computing device 200 may include a communication port 250. The communication port 250 may be connected to and/or from a network to enable data communication. The computing device 200 may also include a processor 220 in the form of one or more processors for executing program instructions. An exemplary computer platform may include an internal communication bus 210, different types of program memories and data memories (e.g., a disk 270, a read-only memory (ROM) 230, or a random access memory (RAM) 240), and various data files processed and/or transmitted by the computer. The exemplary computer platform may also include program instructions executed by the processor 220 stored in ROM 230, RAM 240 and/or other forms of non-transitory storage media. The methods and/or processes of the present disclosure may be implemented in the form of program instructions. The computing device 200 may also include an input/output (I/O) interface 260. The input/output (I/O) interface 260 may support input/output between the computer and other components. The computing device 200 may also receive programming and data via network communication.

For illustration purposes only, only one CPU and/or processor is described in the computing device 200. However, it should be noted that the computing device 200 in some embodiments of the present disclosure may include a plurality of CPUs and/or processors, and thus the operations and/or methods implemented by one CPU and/or processor described in the present disclosure may also be implemented jointly or independently by the plurality CPUs and/or processors. For example, if in the present disclosure, the CPU and/or processor of the computing device 200 performs operations A and B, it should be understood that operations A and B may also be performed jointly or independently (e.g., a first processor may perform the operation A, a second processor may perform the operation B, or the first and second processors may perform the operations A and B jointly) by two different CPUs and/or processors in the computing device 200.

Those skilled in the art will understand that the structure shown in FIG. 2 is merely a block diagram of a portion of the structure related to the solution of the present disclosure, and does not constitute a limitation on the computer device to which the solution of the present disclosure is applied. The specific computer device may include more or fewer components than those shown in the figure, or combine certain components, or have a different arrangement of components.

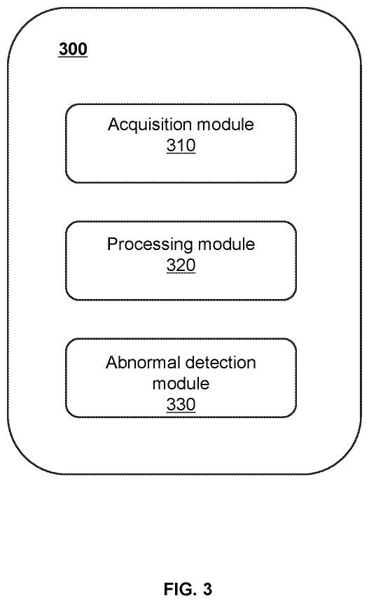

FIG. 3 is a block diagram illustrating an exemplary system for anomaly detection of a carrier plate according to some embodiments of the present disclosure.

In some embodiments, a system 300 for anomaly detection of a carrier plate may include an acquisition module 310, a processing module 320, and an abnormal detection module 330. In some embodiments, the system 300 for anomaly detection of the carrier plate may be implemented by the processor 120.

In some embodiments, the acquisition module 310 may be configured to obtain point cloud data of the carrier plate and a subject placed on the carrier plate. In some embodiments, the acquisition module 310 may be configured to obtain initial point cloud data; and obtain the point cloud data by pre-processing the initial point cloud data.

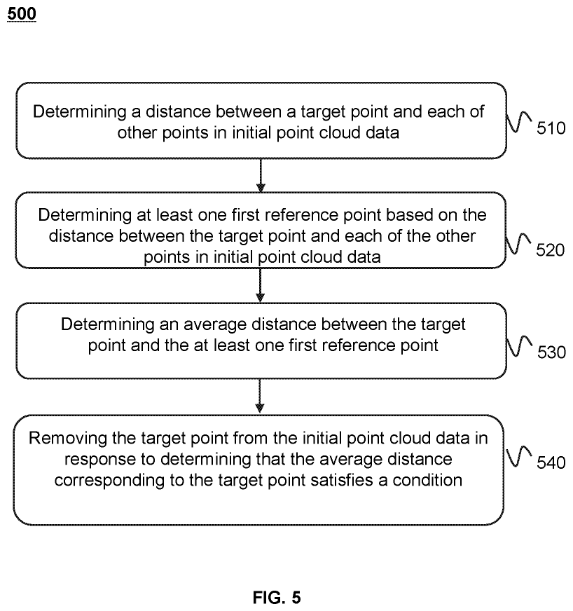

In some embodiments, in order to obtain the point cloud data by pre-processing the initial point cloud data, the acquisition module 310 may be further configured to perform the following operations for each target point in the initial point cloud data: determine a distance between the target point and other points in the initial point cloud data; determine at least one first reference point based on the distance between the target point and the other points; determine an average distance between the target point and the at least one first reference point; and remove the target point from the initial point cloud data in response to determining that the average distance corresponding to the target point satisfies a condition. More descriptions regarding pre-processing may be found in FIG. 4 and FIG. 5 and related descriptions thereof.

In some embodiments, the processing module 320 may be configured to obtain at least one data block by segmenting the point cloud data. In some embodiments, the processing module 320 may be configured to segment the point cloud data based on gradient information of the point cloud data and a gradient distribution rule.

In some embodiments, the abnormal detection module 330 may be configured to perform an anomaly detection of the carrier plate based on the at least one data block.

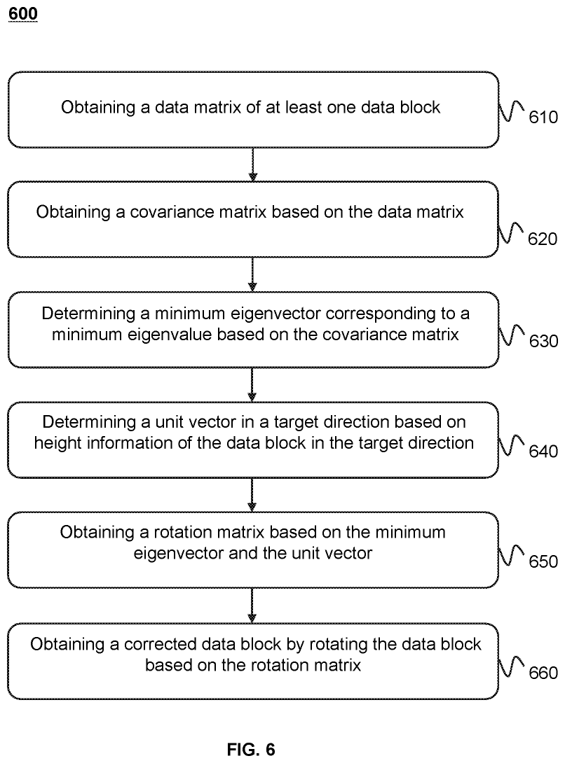

In some embodiments, the anomaly detection module 330 may be configured to obtain at least one corrected data block by correcting the at least one data block; and determine whether the carrier plate involves an anomaly based on the at least one corrected data block. More descriptions regarding the correction may be found in FIG. 4 and FIG. 6 and related descriptions thereof.

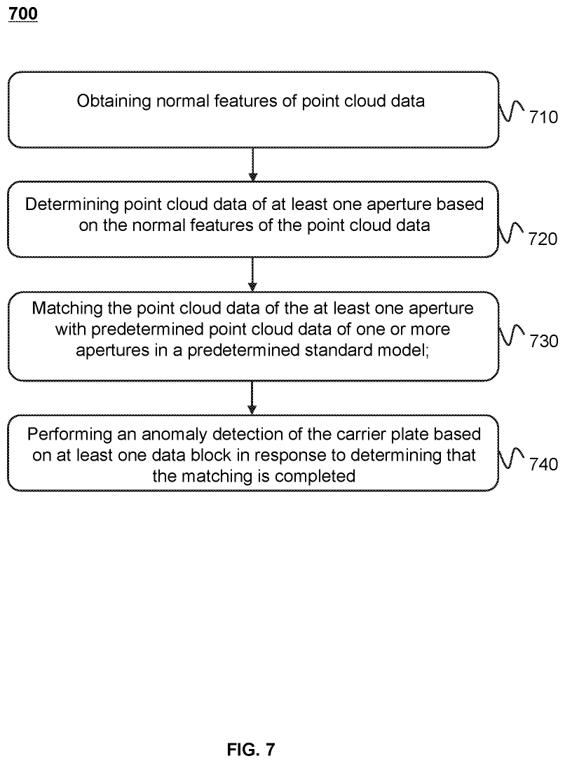

In some embodiments, the abnormal detection module 330 may be further configured to obtain normal features of the point cloud data; determine point cloud data of at least one aperture based on the normal features of the point cloud data; match the point cloud data of the at least one aperture with predetermined point cloud data of the aperture in a predetermined standard model; and perform the anomaly detection of the carrier plate based on the at least one data block in response to determining that the matching is completed. More descriptions regarding the embodiment may be found in FIG. 7 and related descriptions thereof.

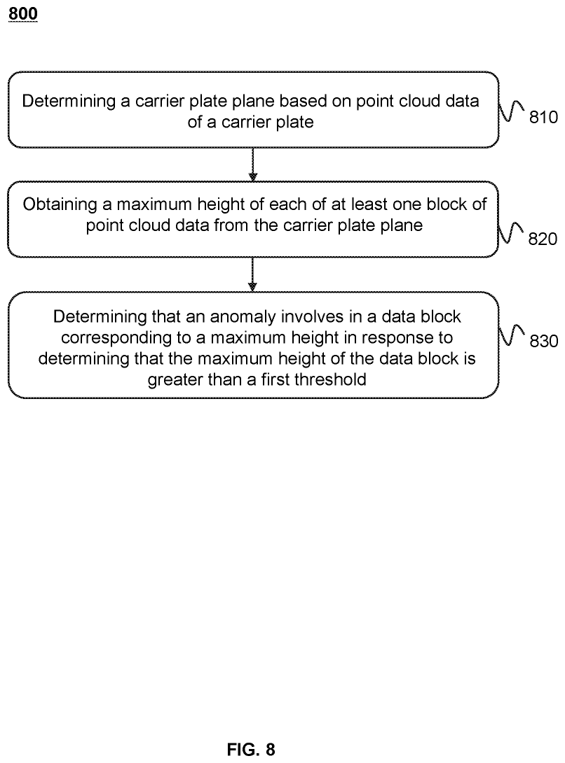

In some embodiments, the abnormal detection module 330 may be configured to determine a carrier plate plane based on point cloud data of the carrier plate, the point cloud data of the carrier plate being determined based on pre-determined point cloud data of the carrier plate in a pre-determined standard model; obtain a maximum height of each of at least one block of point cloud data from the carrier plate plane; and determine that an anomaly involves in a data block corresponding to the maximum height in response to the maximum height being greater than a first threshold. More description regarding the embodiment may be found in FIG. 8 and related descriptions thereof.

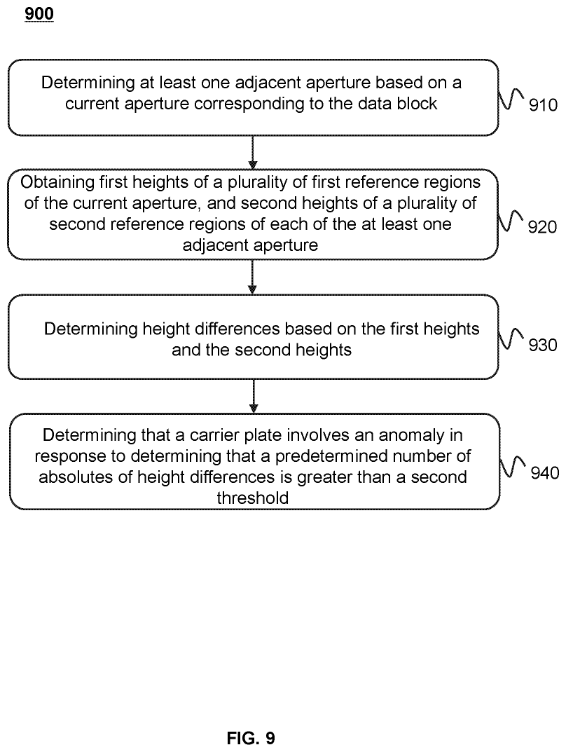

In some embodiments, the abnormal detection module 330 may be further configured to, for each of the at least one data block, determine at least one adjacent aperture based on a current aperture corresponding to the data block; obtain first heights of a plurality of first reference regions of the current aperture, and second heights of a plurality of second reference regions of each of the at least one adjacent aperture, the first reference regions and the second reference regions comprising a raised area in a surface of the subject; determine height differences based on the first heights and the second heights; and determine that the carrier plate involves an anomaly in response to determining that a predetermined number of absolutes of height differences among the height differences based on the first heights and the second heights is greater than a second threshold. More description regarding the embodiment may be found in FIG. 9 and related descriptions thereof.

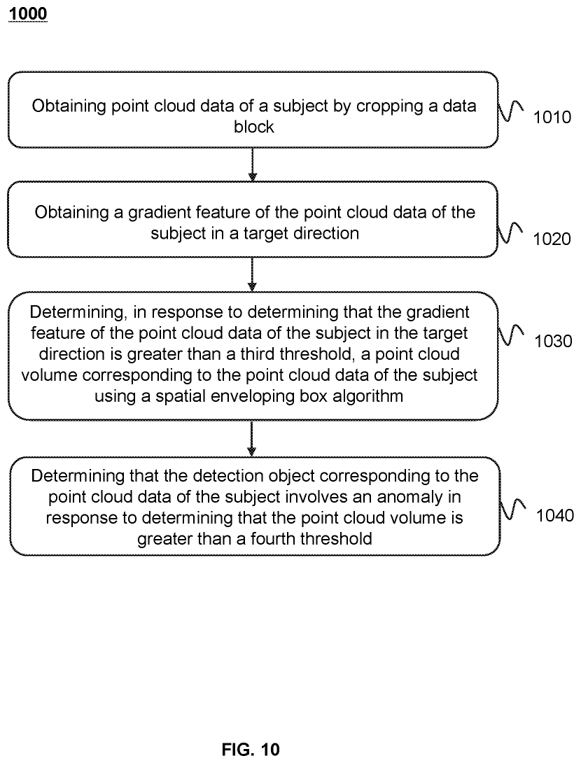

In some embodiments, the abnormal detection module 330 may be further configured to, for each of the at least one data block, obtain point cloud data of the subject by cropping the data block; obtain a gradient feature of the point cloud data of the subject in a target direction; determine, in response to determining that the gradient feature of the point cloud data of the subject in the target direction is greater than a third threshold, a point cloud volume corresponding to the point cloud data of the subject using a spatial enveloping box; and determine that the subject corresponding to the point cloud data of the subject involves an anomaly, in response to the point cloud volume being greater than a fourth threshold. More description regarding the embodiment may be found in FIG. 10 and related descriptions thereof.

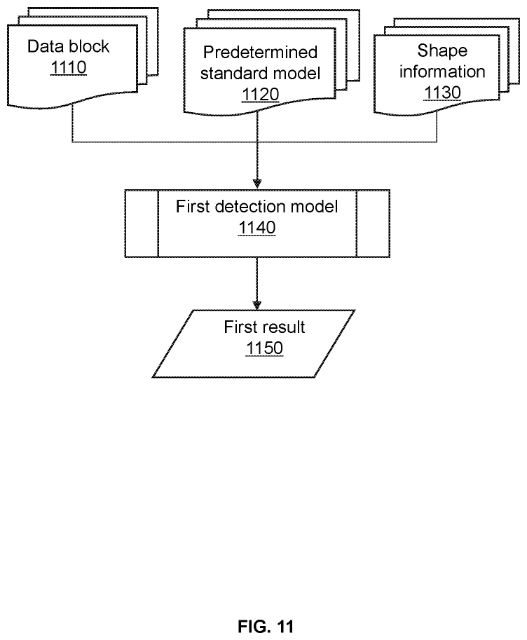

In some embodiments, the abnormal detection module 330 may be further configured to determine a first result by a first detection model based on the at least one data block, a predetermined standard model, and shape information of the subject. The first result may comprise whether the data block involves a hitching anomaly. The first detection model may be a trained machine learning model. More description regarding the embodiment may be found in FIG. 11 and related descriptions thereof.

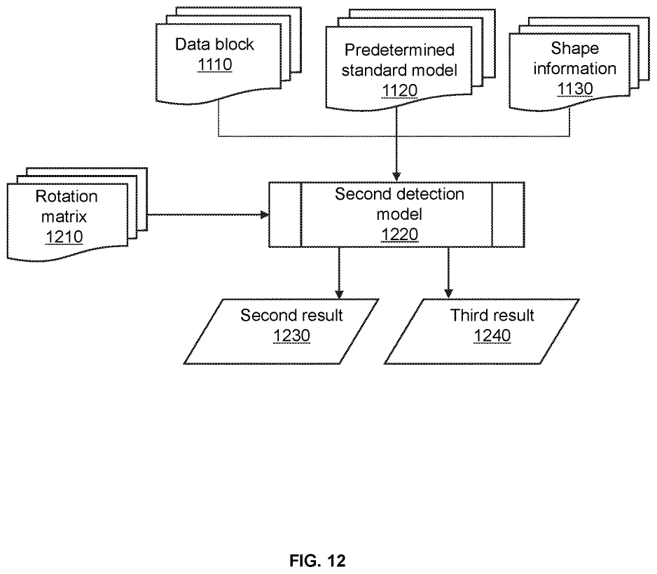

In some embodiments, the abnormal detection module 330 may be further configured to determine at least one of a second result and a third result by a second detection model based on the at least one data block, the predetermined standard model, the shape information of the subject, and at least one rotation matrix corresponding to the at least one data block. The second result may include whether an empty piece involves in the carrier plate and an empty piece parameter. The third result may include whether a foreign object involves in the carrier plate and a foreign object parameter. The second model may be a machine learning model. More description regarding the embodiment may be found in FIG. 12 and related descriptions thereof.

In some embodiments, the abnormal detection module 330 may be further configured to determine the first result by the first detection model based on the at least one data block, the predetermined standard model, and the shape information of the subject; and at least one of the second result and the third result by the second detection model based on the at least one data block, the predetermined standard model, the shape information of the subject, the at least one rotation matrix corresponding to the at least one data block, and the first result. The first result may include whether the data block involves the hitching anomaly. The second result may include whether the empty piece involves in the carrier plate and the empty piece parameter. The third result may include whether the foreign object involves in the carrier plate and the foreign object parameter. The second detection model may be a machine learning model. The first detection model and the second detection model may be obtained by joint training.

It should be noted that the above description of the anomaly detection system 300 and the modules thereof is only for the convenience of description, and does not limit the present disclosure to the scope of the embodiments. It should be understood that for those skilled in the art, after understanding the principle of the system, it is possible to arbitrarily combine the various modules, or form a subsystem to connect with other modules without deviating from this principle. In some embodiments, the acquisition module 310, the processing module 320, and the abnormal detection module 330 disclosed in FIG. 3 can be different modules in a system, or a module can implement the functions of two or more of the above modules. For example, each module can share a storage module, or each module can have its own storage module. Such variations are all within the scope of protection of the present disclosure.

FIG. 4 is a flowchart illustrating an exemplary method for anomaly detection of a carrier plate according to some embodiments of the present disclosure. In some embodiments, a process 400 may be executed by a processor (e.g., the processor 120). For example, the process 400 may be stored in a storage device (e.g., the storage device 130) in the form of programs or instructions, and when the processor executes the programs or instructions, the process 400 may be implemented. The schematic diagram illustrating operations of the process 400 presented below is illustrative. In some embodiments, the process may be completed using one or more additional operations not described and/or one or more operations not discussed. In addition, the order of the operations of the process 400 shown in FIG. 4 and described below is not limiting. As shown in FIG. 4, the process 400 may include the following operations.

In 410, the processor 120 may obtain point cloud data of a carrier plate and a subject placed on the carrier plate. In some embodiments, the operation 410 may be performed by the processor 120 or the acquisition module 310.

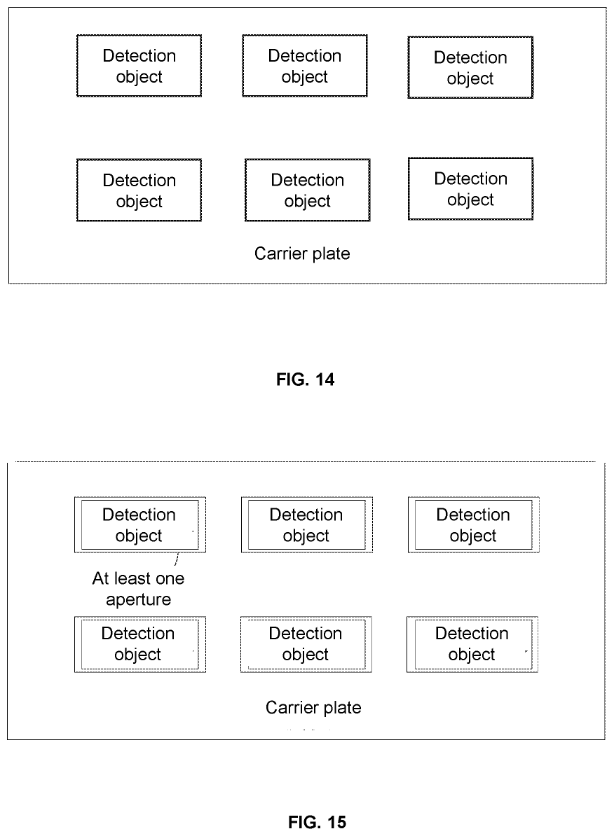

The carrier plate refers to a bearing structure for placing the subject. The anomaly detection of the carrier plate may include placing the subject on the carrier plate and determining whether the carrier plate involves an anomaly to ensure that the subject is not be damaged due to the anomaly during the subsequent processing of the subject. As shown in FIG. 14, FIG. 14 is a schematic structural diagram illustrating the carrier plate.

Furthermore, the carrier plate may be provided with at least one aperture, and the subject may be placed in one of the at least one aperture. The subject may be fixed by a clamping groove in the one of the at least one aperture in the carrier plate. As shown in FIG. 15, FIG. 15 is a schematic structural diagram illustrating the detection of the carrier plate.

In some embodiments, the subject may be made of one or more materials. For example, a material of the subject may include at least one of: silicon (Si), germanium (Ge), silicon germanium (SiGe), carbon silicon (SiC), carbon germanium silicon (SiGeC), indium arsenide (InAs), gallium arsenide (GaAs), indium phosphide (InP), III/compound semiconductor, a multilayer structure composed of these semiconductors, silicon on insulator (SOI), stacked silicon on insulator (SSOI), stacked silicon germanium on insulator (S-SiGeOI), silicon germanium on insulator (SiGeOI), germanium on insulator (GeOI), etc. Merely by way of example, the subject may be a silicon wafer.

In some embodiments, the point cloud data may include position information of the carrier plate and the subject. Merely by way of example, a reference coordinate system related to the carrier plate may be constructed. The reference coordinate system may be a three-dimensional coordinate system having an X-axis, a Y-axis, and a Z-axis. The Y-axis may be parallel to an axial direction of the carrier plate. The X-axis may be perpendicular to the Y-axis and form an X-Y plane parallel or approximately parallel to the carrier plate. The Z-axis may be perpendicular to the X-Y plane. Coordinates of physical points in the reference coordinate system may include one or more of an X-coordinate on the X-axis, a Y-coordinate on the Y-axis, and a Z-coordinate on the X-axis. The Z-coordinate may be used to denote a relative height of each of the physical points relative to a sensor.

In some embodiments, the point cloud data may include point cloud data corresponding to the carrier plate, point cloud data corresponding to the subject placed on the carrier plate, point cloud data corresponding to the at least one aperture, etc.

More descriptions regarding the point cloud data may be found in FIG. 1A and related descriptions thereof.

In some embodiments, the point cloud data may be unprocessed data. The processor may directly obtain the point cloud data through an imaging device (e.g., the imaging device 110). For example, the processor may directly obtain the point cloud data of the carrier plate and the subject through laser scanning, or the like.

In some embodiments, the point cloud data may be processed data. The processor may read the point cloud data from a storage device. The storage device may be the storage device 130 provided in the anomaly detection system, or may be an external storage device that does not belong to the system 100, such as a hard disk, an optical disk, etc. In some embodiments, the point cloud data may be read through an interface. The interface may include a program interface, a data interface, a transmission interface, etc. In some embodiments, when the anomaly detection system is operating, the point cloud data may be automatically obtained from the interface. In some embodiments, the anomaly detection system may be called by other external devices or systems, and the point cloud data may be transmitted to the anomaly detection system when the anomaly detection system is called.

In some embodiments, the processor may obtain initial point cloud data; and obtain the point cloud data by pre-processing the initial point cloud data.

The initial point cloud data refers to unprocessed point cloud data. For example, the initial point cloud data may contain noise points (stray points, outliers, island points, etc.). In some embodiments, the initial point cloud data may be obtained by the imaging device (e.g., the imaging device 110).

Pre-processing refers to an operation of processing the initial point cloud data. In some embodiments, pre-processing may be performed in various ways. For example, pre-processing may include eliminating overly dispersed data in the point cloud data. As another example, pre-processing may include point cloud filtering by bilateral filtering, Gaussian filtering, conditional filtering, pass through filtering, random sampling consistent filtering, VoxelGrid filtering, etc.

More descriptions regarding pre-processing the initial point cloud data may be found in the related descriptions of FIG. 5.

By pre-processing the initial point cloud data, point cloud data that is useful for anomaly detection of a carrier plate can be effectively determined, and redundant interference data can be removed, which is beneficial to improving the accuracy of the point cloud data.

In 420, the processor 120 may obtain at least one data block by segmenting the point cloud data. In some embodiments, the operation 420 may be performed by the processor 120 or the processing module 320.

Segmenting refers to a process of dividing the point cloud data into smaller, and more manageable parts (i.e., “blocks”). In some embodiments, each of the at least one data block may represent a subject on the carrier plate. The at least one data block refers to at least one data block determined based on the gradient distribution rule.

The processor may segment the point cloud data in various ways. In some embodiments, the processor may segment the point cloud data based on the position of the subject represented in the point cloud data. For example, the processor may detect a position of the subject in the point cloud data and divide one or more data points at the position of the subject or within a certain range of the position of the subject into a data block. In some embodiments, the processor may obtain the at least one data block by dividing the point cloud data based on a position distribution of the subject on the carrier plate.

In some embodiments, the processor may segment the point cloud data based on gradient information of the point cloud data and a gradient distribution rule.

The gradient information refers to a gradient size of the point cloud data in a certain direction, which is used to describe a local change of the point cloud data. For example, the subject placed on the carrier plate usually has a certain shape, so the point cloud data of an edge of the subject may be distinguished by gradients in an x-direction and a y-direction (also referred to as an x-direction gradient and a y-direction gradient). For example, taking a subject being or similar to a cuboid as an example, the x-direction gradient and the y-direction gradient of point cloud data at an edge of the cuboid may be relatively large, while the x-direction gradient and the y-direction gradient of point cloud data of the carrier plate plane may be almost 0.

The gradient distribution rule refers to a distribution rule of gradient sizes of the point cloud data in different directions.

In some embodiments, the gradient distribution rule may include the distribution rule of the gradient sizes of the point cloud data in a certain direction. For example, when the subject is placed on the carrier place, a z-direction gradient of an edge of the subject may be relatively large, while a z-direction gradient of the point cloud data of the carrier plate plane may be almost 0. Therefore, the distribution rule of the point cloud data may include that z-direction gradient is relatively large, and the position of the subject may be distinguished by the size of the z-direction gradient.

In some embodiments, the gradient distribution rule may include a distribution rule of the gradient sizes of the point cloud data in two directions. For example, taking a subject being or similar to a cuboid as an example, an x-direction gradient and a y-direction gradient of the point cloud data at an edge of the cuboid may be relatively large, while an x-direction gradient and a y-direction gradient of the point cloud data of the carrier plate plane may be almost 0. Therefore, the distribution rule of the point cloud data may include that the x-direction gradient and the y-direction gradient is a relatively large, and the position of the subject may be distinguished by the size of the x-direction gradient and the y-direction gradient.

In some embodiments, the processor may obtain a data point set corresponding to each subject by segmenting the point cloud data based on the gradient distribution rule, and then taken a region of one subject and data points within a preset range from the subject as a data block. The preset range may be obtained by the system or manually preset.

The point cloud data at different positions can be effectively distinguished by segmenting the point cloud data based on the gradient distribution rule, thereby clearly distinguishing the point cloud data corresponding to different subjects, which is conducive to the anomaly detection for different subjects.

Segmenting the point cloud data is mainly for data processing efficiency and memory management. Especially when point cloud data of a large-scale scenario or complex environment are processed, loading the entire point cloud data set into memory at one time may lead to problems such as tight computing resources and slow processing speed. Therefore, by segmenting the point cloud data, the at least one data block may be loaded and processed on demand, improving the processing efficiency and reducing the resource consumption.

After segmenting the point cloud data is completed, subsequent point cloud processing tasks (such as feature extraction, registration, classification, semantic segmentation, etc.) may be performed independently for each data block, and finally all processing results may be merged to complete the analysis or reconstruction of the entire point cloud data or the scene represented in the point cloud data.

In 430, the processor 120 may perform an anomaly detection of the carrier plate based on the at least one data block. In some embodiments, the operation 430 may be performed by the processor 120 or the abnormal detection module 330.

The anomaly detection of a carrier plate refers to detecting whether an anomaly e.g., damage, an empty piece, and a foreign object) involves in the carrier plate and/or the subject placed on the carrier plate. More descriptions for the anomaly may be found elsewhere in the present disclose.

In some embodiments, the processor 120 may perform the anomaly detection of the carrier plate by analyzing the at least one data block simultaneously.

In order to accelerate the processing of large-scale point cloud data, a multi-core architecture of a modern processor may be effectively utilized based on the multi-threading technique. In some embodiments, when the point cloud data is segmented into at least one data block, a separate thread may be assigned to each data block for parallel processing, thereby significantly reducing the processing time. It should be noted that multi-threading technology requires good task division strategies and synchronization mechanisms to ensure data consistency and avoid race conditions.

In some embodiments, the anomaly detection of the carrier plate may be performed by analyzing each data block based on the multi-threading technique.

In some embodiments, the processor may perform the anomaly detection of the carrier based on various ways. For example, the processor may perform the anomaly detection of the carrier plate based on a count of the at least one data block. When the count of the at least one data block is less than a count of at least one aperture of the carrier plate, it is determined that the carrier plate involves an anomaly of empty piece. The at least one data block refers to at least one data block determined based on the gradient distribution rule. More descriptions regarding the at least one aperture and the anomaly of empty piece may be found below.

In some embodiments, before the anomaly detection of the carrier plate is performed based on the at least one data block, the processor may correct the at least one data block to obtain at least one corrected data block; and determine whether the carrier plate involves an anomaly based on the at least one corrected data block.

In some embodiments, the processor may correct the at least one data block in various ways. For example, the processor may perform horizontal correction of the at least one data block. More descriptions regarding the correction may be FIG. 6 and related descriptions thereof.

In some embodiments, before the at least one data block is corrected, the processor may determine whether to correct a data block based on height information of the data block in a target direction.

In some embodiments, the target direction refers to a direction perpendicular to a surface (e.g., horizontal plane) of the carrier plate where the subject is located. For example, the target direction may be the Z-axis direction in the reference coordinate system.

The height information of a data block refers to distance or length information of the data block in the target direction.

In some embodiments, for a data block, the processor may determine gradient values of any two data points in the at data block in the target direction based on the height information of the data block in the target direction.

In some embodiments, the processor may determine whether to correct the data block in various ways based on the gradient values of any two data points in the data block in the target direction. For example, the processor may determine to correct the data block in response to determining that the gradient values of two data points in the data block in the target direction are greater than a gradient threshold. As another example, the processor may determine to correct the data block in response to determining that gradient values of a predetermined number of data points in the data block in the target direction are greater than a gradient threshold. The gradient threshold and the predetermined number may be system default values, empirical values, manually preset values, or the like, or any combination thereof, and may be set according to actual needs, which is not limited in the present disclosure.

Due to the problem of an installation angle of the imaging device, a scanning plane of the imaging device and the plane of the carrier plate may not be parallel, and the point cloud data obtained by scanning may be tilted. Determining a height difference between the two data points based on the tilted point cloud data may result in errors. To this end, it is necessary to add the operation of correcting the at least one data block. In some embodiments of the present disclosure, it is determined whether to correct the point cloud data based on the height information of a point cloud database in the target direction, which can effectively determine the point cloud data that needs to be corrected, avoiding resource consumption caused by the correction processing of the at least one data block that do not need to be corrected, and improving the efficiency of data processing.

In some embodiments of the present disclosure, whether the carrier plate involves the anomaly may be determined based on the at least one corrected data block, so as to further standardize the point cloud data and detect whether the subject involves a position anomaly, thereby avoiding damage to the subsequent process quality, and reducing the defect rate of products.

In some embodiments, the processor may skip the correction operation and directly perform the anomaly detection of the at least one data block.

The anomaly detection may be performed in various ways. In some embodiments, a result of the anomaly detection may include one of a hitching anomaly, an empty piece anomaly, a foreign object anomaly, or the like, on the carrier plate.

The hitching anomaly means that the subject is not completely placed at a fixed position or region and, at least a portion of the subject falls outside the fixed position or region. For example, when the carrier plate is provided with at least one aperture, the subject (e.g., the silicon wafer) needs to be placed in an aperture. Under normal circumstances, the aperture may be larger than the subject (e.g., the silicon wafer). If the subject (e.g., silicon wafer) is completely placed in the aperture, the subject (e.g., silicon wafer) may be placed normally. If the aperture is smaller than the subject (e.g., silicon wafer), or the subject (e.g., the silicon wafer) is not completely placed in the aperture, i.e., one or two corners of the subject (e.g., the silicon wafer) protrudes and fall outside the aperture, the carrier plate may involve the hitching anomaly.

The empty piece refers to that a fixed position in the carrier plate is not provided with a subject, i.e., the fixed position in the carrier plate is in an empty state. For example, when the carrier plate is provided with the at least one aperture, subjects (e.g., the silicon wafers) need to be placed in the at least one aperture. If an aperture is not provided with a subject, the carrier plate may involve the empty piece anomaly.

In some embodiments, the processor may be configured to compare position information contained in a data block with position information contained in a standard data block. When a comparison result is that a vector distance between the position information contained in the data block and the position information contained in the standard data block is greater than a distance threshold, the processor may determine that an anomaly involves in the carrier plate. Further, the processor may query a preset comparison table based on the vector distance to determine an anomaly type corresponding to the vector distance. The preset comparison table may be predetermined based on historical data or prior knowledge. The preset comparison table may include corresponding results of different vector distances and different anomaly types.

In some embodiments, the carrier plate may be provided with at least one aperture, and each of at least a portion of the at least one aperture may have a subject placed therein. The processor may obtain normal features of the point cloud data; determine point cloud data of the at least one aperture based on the normal features of the point cloud data; obtain a positioning result of the point cloud data of the at least one aperture by matching the point cloud data of the at least one aperture with predetermined point cloud data of the aperture in a predetermined standard model; and perform the anomaly detection of the at least one data block based on the positioning result and the height information contained in the point cloud data.

More descriptions regarding the embodiment may be found in FIG. 7 and related descriptions thereof.

In some embodiments, the processor may be configured to determine a plane of the carrier plate (also referred to as the carrier plate plan) based on point cloud data of the carrier plate; obtain a maximum height of each of the at least one data block from the carrier plate plane; and determine that an anomaly involves in a data block corresponding to the maximum height in response to the maximum height being greater than a first threshold. The point cloud data of the carrier plate may be determined based on pre-determined point cloud data of the carrier plate in a pre-determined standard model. The maximum height of the at least one data block refers to that a maximum value among heights each of which is from one of the at least one data block to the carrier plate plane.

More descriptions regarding the embodiment may be found FIG. 8 and related descriptions thereof.

In some embodiments, the processor may, for each of the at least one data block, determine at least one adjacent aperture based on a current aperture corresponding to the data block, and obtain first heights of a plurality of first reference regions of the current aperture, and second heights of a plurality of second reference regions of each of the at least one adjacent aperture. The processor may determine height differences based on the first heights and the second heights and determine that the current aperture involves an anomaly in response to determining that a predetermined number of absolutes of height differences between the first heights and the second heights corresponding to the at least one data block is greater than a second threshold. The first reference regions and the second reference regions may include a raised area in a surface of the subject

More descriptions regarding the embodiment may be found FIG. 9 and related descriptions thereof.

In some embodiments, the processor may be configured to perform the anomaly detection of the carrier plate based on the at least one data block according to operations including for each of the at least one data block, obtaining point cloud data of the subject by cropping the data block; obtaining a gradient feature of the point cloud data of the subject in a target direction; determining, in response to determining that the gradient feature of the point cloud data of the subject in the target direction is greater than a third threshold, a point cloud volume corresponding to the point cloud data of the subject using a spatial enveloping box; and determining that the subject involves an anomaly in response to the point cloud volume being greater than a fourth threshold.

More descriptions regarding the embodiment may be found FIG. 10 and related descriptions thereof.

In some embodiments, the processor may perform the anomaly detection of the carrier plate using a machine learning model. More description regarding performing the anomaly detection of the carrier plate using the machine learning model may be found in FIGS. 11-13 and related descriptions thereof.

In some embodiments of the present disclosure, after the point cloud data is obtained and the point cloud data is segmented, and the at least one data block may be loaded and processed on demand, which improves the processing efficiency and reduces resource waste. After segmenting the point cloud data is completed, a detection task of the anomaly detection of the point cloud data may be performed independently for each of the at least one data block, significantly reducing the processing time, and quickly locating anomalies, thereby improving the anomaly detection efficiency, avoiding damage to the subsequent process quality, and reducing the defect rate of products.

FIG. 5 is a flowchart illustrating an exemplary process of pre-processing according to some embodiments of the present disclosure. In some embodiments, a process 500 may be performed by a processor (e.g., the processor 120). For example, the process 500 may be stored in a storage device (e.g., the storage device 130) in the form of programs or instructions, and when the processor executes the programs or instructions, the process 500 may be implemented. The schematic diagram illustrating operations of the process 500 below is illustrative. In some embodiments, the process may be completed using one or more additional operations not described and/or one or more operations not discussed. In addition, the order of the operations of the process 500 shown in FIG. 5 and described below is not limiting. As shown in FIG. 5, the process 500 may include the following operations.

In some embodiments, the initial point cloud data may include multiple points. Each of at least a portion of the multiple points may be designated as a target point for pre-processing. The processor may perform operations 510-540 for each target point in initial point cloud data to perform e pre-processing of the initial point cloud data.

In 510, the processor 120 may determine a distance between a target point and each of other points in initial point cloud data.

The target point refers to a data point in the initial point cloud data. In some embodiments, the target point may be randomly selected or manually selected.

The other points in initial point cloud data refer to other data points in the initial point cloud data excluding the currently selected target point.

In some embodiments, the processor may determine a straight-line distance between the target point and each of the other points in the initial point cloud data. The straight-line distance between the target point and each of the other points in the initial point cloud data may be designated as the distance between the target point and each of other points in the initial point cloud data.

In 520, the processor 120 may determine at least one first reference point based on the distances between the target point and each of the other points in the initial point cloud data.

A first reference point refers to a point in initial point cloud data that is close to the target point.

In some embodiments, the processor may sort the distances between the target point and the other points in the initial point cloud data (e.g., in an ascending order, i.e., the higher the ranking, the smaller the distance, and the lower the ranking, the greater the distance.) to obtain a distance sort and determine, based on the distance sort, a first predetermined number of points in the initial point cloud data (e.g., ranking the top of the distance sort) as the at least one first reference point. The first predetermined number may be a system default value, an empirical value, a manually preset value, or any combination thereof, and may be set based on actual needs, which is not limited in the present disclosure. For example, the first predetermined number may be 5, and the processor may select the top 5 other points in the initial point cloud data in the distance sort as the at least one first reference point.

In some embodiments, the processor may determine a point whose distance from the target point is less than a distance threshold as a first reference point.

In 530, the processor 120 may determine an average distance between the target point and the at least one first reference point.

The average distance refers to an average value of the distance between the target point and the at least one first reference point. In some embodiments, the average distance may be an average value of the distance between the target point and the first predetermined number of first reference points. For example, if the first predetermined number is 20, points corresponding to the top 20 distances in the distance sort may be obtained. These points may be used as the predetermined number of first reference points to determine he average distance between the target point and the first predetermined number of first reference points.

In some embodiments, if there is only one first reference point, the average distance may be a distance between the only one first reference point and the target point.

In 540, the processor 120 may remove the target point from the initial point cloud data in response to determining that the average distance corresponding to the target point satisfies a condition.

The condition refers to a restriction condition related to the average distance. For example, the condition may be that the average distance is greater than a distance threshold. The distance threshold may be a system default value, an experience value, a manually preset value, or any combination thereof, and may be set based on actual needs, which is not limited in the present disclosure.

In some embodiments, the condition may include that the average distance is less than a first distance threshold or the average distance is greater than a second distance threshold. The first distance threshold may be less than the second distance threshold.

In some embodiments, the first distance threshold and the second distance threshold may be determined in various ways. For example, the first distance threshold and/or the second distance threshold may be system default values, empirical values, manually preset values, or any combination thereof, and may be set based on actual needs, which is not limited in the present disclosure.

In some embodiments, the first distance threshold may be determined based on remaining computational resources of the anomaly detection system. For example, the first distance threshold may be negatively correlated to the remaining computational resources of the anomaly detection system.

The remaining computational resources refer to remaining available computational resources of the anomaly detection system. In some embodiments, the remaining computational resources may be obtained by calculation. For example, the remaining computational resources may be a value obtained by 100% minus the current central processing unit (CPU) usage.

By determining the first distance threshold through the remaining computational resources of the anomaly detection system, the operation efficiency of the system can be effectively ensured. Meanwhile, the computational resources can be reasonably allocated and utilized, ensuring the safety and stable operation of the system, and avoiding the waste of computational resources.

In some embodiments, the processor may determine the second distance threshold according to operations including determining, for each of a plurality of predetermined points in a predetermined standard model, an average distance between the predetermined point and remaining predetermined points in the predetermined standard model; and determining the second distance threshold based on the average distances corresponding to the plurality of predetermined points.

The predetermined standard model refers to standard point cloud data when there is no subject placed on the carrier plate and no foreign object exists. The predetermined standard model may be obtained in advance. For example, when there is no subject placed on the carrier plate, the point cloud data of the carrier plate obtained after the carrier plate is cleaned may be used as the predetermined standard model.

In some embodiments, the predetermined standard model may include predetermined point cloud data of the aperture (i.e., standard point cloud data of the aperture) and predetermined point cloud data of the carrier plate (i.e., standard point cloud data of the carrier plate).

The plurality of predetermined points refers to data points contained in the predetermined standard model. The plurality of predetermined points may be determined from the predetermined standard model based on random selection or manual selection. The remaining predetermined points corresponding to a predetermined point refer to other predetermined points except the predetermined point.

In some embodiments, the processor may determine, for each of the plurality of predetermined points in the predetermined standard model, the average distance between the predetermined point and the remaining predetermined points in the predetermined standard model; and determine a statistical value of the average distances corresponding to the plurality of predetermined points as the second distance threshold. The statistical value of the average distances may include a mean value, a median value, a maximum value, a minimum value, etc., of the average distances.

The second distance threshold may be determined by determining the statistical value of the average distances corresponding to the plurality of predetermined points in the predetermined standard model, thereby effectively improving the accuracy of the second distance threshold.

In some embodiments, the processor may determine a mean and standard deviation based on a k-neighborhood distance distribution of each of the plurality of predetermined points according to a statistical mathematical model to construct a normal distribution diagram and determine a predetermined interval, and filter out predetermined points of which average distances are not within the predetermined interval, so that the average distances corresponding to all the retained predetermined points are within the predetermined interval, thereby obtaining filtered predetermined points.

If the average distances corresponding to all the filtered predetermined points obey a normal distribution, the processor may take a mean value of the average distances corresponding to the plurality of predetermined points contained in the determined standard model as expectation u, and a normal distribution diagram may be constructed with three standard deviations (i.e., 3σ, σ denotes the standard deviation of the average distances corresponding to the plurality of predetermined points) as the standard, and then a predetermined interval may be determined. The predetermined interval enables a certain proportion (e.g., 95%) of the predetermined points to fall within the predetermined interval. The predetermined interval may construct the predetermined interval (μ−3σ, μ+3σ) by taking the expectation u as a midpoint of the interval. Further, the processor may take a lower limit μ−3σ of the predetermined interval (μ−3σ, μ+3σ) as the first distance threshold, and take an upper limit μ+3σ of the predetermined interval (μ−3σ, μ+3σ) as the second distance threshold.

In some embodiments of the present disclosure, according to process 500, one or more target points whose average distances are less than the first distance threshold may be removed from the initial point cloud data. The one or more target points whose average distances are close may be rejected to remove redundant data, reducing the amount of subsequent computation, and improving processing speed. One or more target points whose average distances are greater than the second distance threshold may be removed. The one or more target points of which the average distances are far may be removed, avoiding adverse effects on subsequent computation.

In some embodiments, the processor may reject the one or more target points from the initial point cloud data in response to determining that the average distance corresponding to each of the one or more target points satisfies the condition. For example, the processor may reject the one or more target points whose average distances are less than the first distance threshold, and/or reject the one or more target points of which the average distances are greater than the second distance threshold.

In some embodiments, for each of the one or more target points selected from the initial point cloud data, distance ranking corresponding to each target point may be determined, at least one first reference point corresponding to each target point may be determined therefrom, and then the average distance between each target point and the at least one first reference point corresponding to the target point may be determined. The target point may be removed or retained based on whether the average distance corresponding to each target point satisfies the condition.

In some embodiments of the present disclosure, by removing the target points from the initial point cloud data in response to determining that the average distance corresponding to the target point satisfies the condition, the point cloud data can be further optimized to remove redundant or unnecessary data, thereby reducing the amount of computation, and ensuring more efficient operation of the system.

FIG. 6 is a flowchart illustrating an exemplary correction process of a data block according to some embodiments of the present disclosure. In some embodiments, process 600 may be executed by a processor (e.g., the processor 120). For example, the process 600 may be stored in a storage device (e.g., the storage device 130) in the form of a program or instruction, and when the processor executes the program or instruction, the process 600 may be implemented. An operational schematic diagram of the process 600 presented below is illustrative. In some embodiments, the process 600 may be completed using one or more additional operations not described and/or one or more operations not discussed. In addition, an order of operations of the process 600 shown in FIG. 6 and described below is not restrictive. As shown in FIG. 6, the process 600 includes following operations.

In some embodiments, the processor may perform operations 610-660 on a portion or all of data blocks in at least one data block to perform a correction of the at least one data block.

In 610, a data matrix of the data block may be obtained.

The data matrix refers to matrix data obtained by representing the data block in a matrix form. The data matrix may be a matrix with N rows and at least 3 columns. N represents a count of data points, and each row represents a data point. Usually, 3 columns are three-dimensional coordinates of a data point in space. If point cloud data has additional information (e.g., point cloud data from a LIDAR sensor) in addition to the coordinates in space, then it may have an additional value of each data point, for example, “reflectivity”, which is a measure of how much laser beam is reflected by an obstacle in a specific position. In this case, the data block may be represented as a data matrix of an N×4 array.

In some embodiments, the processor may construct the data matrix corresponding to the data block based on position information of each data point contained in the data block. For example, the processor may designate a count of data points contained in the data block as a count of rows of the data matrix and three-dimensional coordinates contained in each data point as column elements of the data matrix to obtain the data matrix corresponding to the data block.

In 620, a covariance matrix may be obtained based on the data matrix.

The covariance matrix may measure the correlation between two variables, which is used to describe a linear relationship between the variables. A variable consists of a plurality of components. Each element on the diagonal of the covariance matrix represents a variance of each of the plurality of components, and each of the other elements off the diagonal represents a covariance between two components in the variable.

In some embodiments, the processor may determine a centroid of the data block based on the data matrix. For example, based on position coordinates of all data points contained in the data block, an average value of the position coordinates of all data points is determine to obtain the centroid. Merely by way of an example, the centroid (Cₓ, C_{y}, C_{z}) may be determined using the following formula (1):

$${C}_{x} = ( {x}_{1} + {x}_{2} + {x}_{3} + … + {x}_{n} ) / n \qquad ( 1 )$$

$${C}_{y} = ( {y}_{1} + {y}_{2} + {y}_{3} + … + {y}_{n} ) / n$$

$${C}_{z} = ( {z}_{1} + {z}_{2} + {z}_{3} + … + {z}_{n} ) / n ,$$

wherein (x₁, x₂, x₃, . . . , xₙ) are x-coordinates of all data points in the data block, (y₁, y₂, y₃, . . . , yₙ) are y-coordinates of all data points in the data block, (z₁, z₂, z₃, . . . , zₙ) are z-coordinates of all data points in the data block, and n is a total count of data points in the data block.

In some embodiments, the processor may determine offsets each of which is between a data point contained in the data block and the centroid, and then determine each element in the covariance matrix based the offsets. For example, for each data point (xᵢ, yᵢ, zᵢ) in the data block, the offset between the data point and the centroid may be determined by the following formula (2):

$${d}_{x} = {x}_{i} - {C}_{x} \qquad ( 2 )$$

$${d}_{y} = {y}_{i} - {C}_{y}$$

$${d}_{z} = {z}_{i} - {C}_{z} ,$$

wherein dₓ is an offset between the x-coordinate of the data point and the x-coordinate of the centroid, d_{y} is an offset between the y-coordinate of the data point and the y-coordinate of the centroid, and d_{z} is an offset between the z-coordinate of the data point and the z-coordinate of the centroid.

Furthermore, each element in the covariance matrix may be determined based on the following formula (3):

$${C}_{x x} = ( {d}_{{x}_{1}} * {d}_{{x}_{1}} + {d}_{{x}_{2}} * {d}_{{x}_{2}} + {d}_{{x}_{3}} * {d}_{{x}_{3}} + … + {d}_{{x}_{n}} * {d}_{{x}_{n}} ) / n \qquad ( 3 )$$

$${C}_{x y} = ( {d}_{{x}_{1}} * {d}_{{y}_{1}} + {d}_{{x}_{2}} * {d}_{{y}_{2}} + {d}_{{x}_{3}} * {d}_{{y}_{3}} + … + {d}_{{x}_{n}} * {d}_{{y}_{n}} ) / n$$

$${C}_{x z} = ( {d}_{{x}_{1}} * {d}_{{z}_{1}} + {d}_{{x}_{2}} * {d}_{{z}_{2}} + {d}_{{x}_{3}} * {d}_{{z}_{3}} + … + {d}_{{x}_{n}} * {d}_{{z}_{n}} ) / n$$

$${C}_{y x} = ( {d}_{{y}_{1}} * {d}_{{x}_{1}} + {d}_{{y}_{2}} * {d}_{{x}_{2}} + {d}_{{y}_{3}} * {d}_{{x}_{3}} + … + {d}_{{y}_{n}} * {d}_{{x}_{n}} ) / n$$

$${C}_{y y} = ( {d}_{{y}_{1}} * {d}_{{y}_{1}} + {d}_{{y}_{2}} * {d}_{{y}_{2}} + {d}_{{y}_{3}} * {d}_{{y}_{3}} + … + {d}_{{y}_{n}} * {d}_{{y}_{n}} ) / n$$

$${C}_{y z} = ( {d}_{{y}_{1}} * {d}_{{z}_{1}} + {d}_{{y}_{2}} * {d}_{{z}_{2}} + {d}_{{y}_{3}} * {d}_{{z}_{3}} + … + {d}_{{y}_{n}} * {d}_{{z}_{n}} ) / n$$

$${C}_{z x} = ( {d}_{{z}_{1}} * {d}_{{x}_{1}} + {d}_{{z}_{2}} * {d}_{{x}_{2}} + {d}_{{z}_{3}} * {d}_{{x}_{3}} + … + {d}_{{z}_{n}} * {d}_{{x}_{n}} ) / n$$

$${C}_{z y} = ( {d}_{{z}_{1}} * {d}_{{y}_{1}} + {d}_{{z}_{2}} * {d}_{{y}_{2}} + {d}_{{z}_{3}} * {d}_{{y}_{3}} + … + {d}_{{z}_{n}} * {d}_{{y}_{n}} ) / n$$

$${C}_{zz} = ( {d}_{{z}_{1}} * {d}_{{z}_{1}} + {d}_{{z}_{2}} * {d}_{{z}_{2}} + {d}_{{z}_{3}} * {d}_{{z}_{3}} + … + {d}_{{z}_{n}} * {d}_{{z}_{n}} ) / n ,$$

Finally, the covariance matrix is C(x, y, z) denoted as:

$$[ \begin{matrix}{C}_{x x} & {C}_{x y} & {C}_{x z} \\ {C}_{y x} & {C}_{y y} & {C}_{y z} \\ {C}_{z x} & {C}_{z y} & {C}_{zz}\end{matrix} ] .$$

In 630, a minimum eigenvector corresponding to a minimum eigenvalue may be determined according to the covariance matrix.

The minimum eigenvalue is one of main features of the covariance matrix. The minimum eigenvector refers to an eigenvector corresponding to the smallest eigenvalue.

In some embodiments, the processor may perform a matrix decomposition operation on the covariance matrix according to a matrix decomposition algorithm to obtain the minimum eigenvector corresponding to the minimum eigenvalue. In some embodiments, the processor may perform the matrix decomposition on the covariance matrix based on a singular value decomposition (SVD) algorithm to extract matrix features of the covariance matrix to obtain a maximum eigenvalue of the covariance matrix and a corresponding maximum eigenvector thereof, and the minimum eigenvalue and the corresponding minimum eigenvector thereof.

In 640, a unit vector in a target direction may be determined based on height information of the data block in the target direction.

In some embodiments, the target direction may be a direction perpendicular to a surface of a carrier plate where the subject is located. For example, the target direction may be the Z-axis direction in the aforementioned reference coordinate system. More descriptions regarding the reference coordinate system may be found in FIG. 1A and FIG. 4 and relevant descriptions thereof.

The height information in the target direction refers to a distance or length information of the data block in the target direction.

The unit vector in the target direction refers to a unit vector of the minimum eigenvector in the target direction. For example, the minimum eigenvector may be divided by a modulus of the minimum eigenvector to obtain the unit vector in the target direction. Merely by way of example, the unit vector in the target direction may be (0, 0, 1).

In 650, a rotation matrix may be obtained based on the minimum eigenvector and the unit vector.

The rotation matrix refers to a matrix used to change a direction of the minimum eigenvector but not change the size of the minimum eigenvector when the minimum eigenvector is projected to the target direction.

In some embodiments, the processor may obtain the rotation matrix based on the minimum eigenvector and the unit vector by any feasible manners used for determining the rotation matrix. For example, the rotation matrix may be obtained using the Euler angle, a Rodriguez rotation formula, manners used for determining the rotation matrix based on vector values before and after the rotation, etc.

In 660, a corrected data block may be obtained by rotating the data block based on the rotation matrix.

In some embodiments, the processor may rotate the data block based on the rotation matrix to achieve a horizontal correction of the data block and obtain the corrected data block.

Due to a problem of an installation angle of an imaging device, a scanning plane of the imaging device and the carrier plate plane may not be parallel, and the scanned point cloud data is tilted. Determining the height difference between two data points based on the tilted point cloud data will result in errors. Therefore, by correcting the data block, adverse effects of the tilted point cloud data on a subsequent inspection process may be effectively reduced, and the data may be further standardized to accurately detect whether there is an abnormal position of the subject, thereby avoiding damage to a subsequent process quality and reducing a product defect rate.

FIG. 7 is a flowchart illustrating an exemplary process for performing an anomaly detection after matching positioning according to some embodiments of the present disclosure. In some embodiments, process 700 may be executed by a processor (e.g., the processor 120). For example, the process 700 may be stored in a storage device (e.g., the storage device 130) in the form of a program or instruction, and when the processor executes the program or instruction, the process 700 may be implemented. The operational schematic diagram of the process 700 presented below is illustrative. In some embodiments, the process 700 may be completed using one or more additional operations not described and/or one or more operations not discussed. In addition, an order of operations of the process 700 shown in FIG. 7 and described below is not restrictive. As shown in FIG. 7, the process 700 includes the following operations.

In some embodiments, a carrier plate may be provided with at least one aperture, and one of the at least one aperture has a subject placed therein. Before performing the anomaly detection on the carrier plate, the data block may be matched and positioned based on point cloud data corresponding to the aperture to ensure the accuracy of subsequent detection results.

In 710, normal features of the point cloud data may be obtained.

A normal feature refers to a normal vector of a data point in the point cloud data. In some embodiments, the normal features of the point cloud data may include normal features of all data points in the point cloud data.

The normal features of the point cloud data may be determined in a variety of ways. In some embodiments, the processor may determine a projection of a data point (i.e., point) of the point cloud data in a normal direction as the normal feature of the data point. The normal direction of the data point may be determined based on a line between the data point and two neighboring data points. For example, a direction perpendicular to the line between the data point and the two neighboring data points may be determined as the normal direction. By traversing all the data points in the point cloud data and repeating the above operation, the normal features corresponding to all the data points may be obtained.

In some embodiments, the processor may perform operations 711-714 for each target point in the point cloud data to determine a normal feature of each target point.

In 711, a distance between the target point and each of other points in initial point cloud data may be determined.

More descriptions regarding the target point, the other points in initial point cloud data, and the process for determining the distance between the target point and other points in initial point cloud data may be found in FIG. 5 and relevant descriptions thereof.

In 712, at least one second reference point may be determined based on the distance between the target point and each of other points in initial point cloud data.

The second reference point refers to an initial point that is closer to the target point.

In some embodiments, the processor may sort distances between the target point and other points in the initial point cloud data (e.g., in an ascending order, i.e., the higher the ranking, the smaller the distance, and the lower the ranking, the greater the distance) to obtain a distance sort, and designate a second predetermined count of points in the initial point cloud data (e.g., ranking the top of the distance sort) as the at least one second reference point. The second predetermined count may be a system default value, an empirical value, a manually predetermined value, or any combination thereof, which may be set according to actual needs and is not limited by the present disclosure. Exemplarily, the second predetermined count may be 10, and the processor may select the top 10 other points in the initial point cloud data in the distance sort as the at least one second reference point.

In some embodiments, the processor may determine a point whose distance from the target point is less than a distance threshold as a second reference point.

In 713, a fitting surface may be obtained by fitting the at least one second reference point.

The fitting surface refers to an approximate plane obtained by fitting the scattered second reference points.

The fitting may be performed in a variety of feasible ways. For example, the at least one second reference point may be fitted by least squares fitting, quadratic surface fitting, etc., to obtain the fitting surface.

In 714, a normal feature of a center point of the fitting surface may be designated as the normal feature of the target point.

The center point of the fitting surface refers to a point from which all points on the fitting surface are equidistant. In other words, distances between the center point to other point are the same.

In some embodiments, the processor may traverse the data points on the fitting surface, and determine a data point that is at an equal distance from all other data points to a certain data point as the center point of the fitting surface.

In some embodiments, the processor may determine a projection of the center point in the normal direction as the normal feature of the center point. In some embodiments, the processor may determine the normal feature of the center point as the normal feature of the target point. The normal direction of the center point may be a direction perpendicular to the fitting surface.

For each target point in the point cloud data, the processor may determine the normal feature of the target point through the above operations 711-714.

In 720, point cloud data of the at least one aperture may be determined based on the normal features of the point cloud data.

The point cloud data of an aperture also referred to as aperture point cloud data.

In some embodiments, the processor may determine that the aperture point cloud data corresponding to at least a portion of the at least one aperture.

The normal features of the data points at the aperture boundary of an aperture are usually scattered and disordered, while the normal features of the carrier plate plane are usually regular and consistent. In some embodiments, for an aperture among the at least one aperture, the processor may determine the disordered normal features as the normal features of the data points corresponding to the aperture boundary of the aperture, and then obtain the data points corresponding to the aperture boundary. The processor may further determine the data points surrounded by the aperture boundary based on position information of the data points corresponding to the aperture boundary, and determine the data points corresponding to the aperture boundary and the data points surrounded by the aperture boundary as the point cloud data of the aperture.

In some embodiments, the processor may determine whether the normal features of the data points are disordered based on the normal features of the data points and a predetermined rule. In some embodiments, the predetermined rule may include determining whether the normal features are disordered by determining whether an angle between the normal features of neighboring data points exceeds a predetermined angle threshold. When the angle between the normal features of neighboring data points exceeds the predetermined angle threshold, the processor may determine that the normal features of the neighboring data points are disordered. The predetermined angle threshold may be a system default value, an experience value, a manually predetermined value, etc., or any combination thereof, which may be set according to actual needs and is not limited by the present disclosure.

In other embodiments, the processor may determine the point cloud data of an aperture in the data block.

In some embodiments, the processor may divide the data block into sub-regions with a predetermined size and a predetermined shape. The predetermined size and the predetermined shape may be system default values, empirical values, artificial predetermined values, etc., or any combination thereof, which may be set according to actual needs and is not limited by the present disclosure. For the data points in each sub-region, the processor may determine an angle difference between the normal features of every two data points, and then determine a maximum angle difference among the angle differences each of which is between the normal features of two data points in the sub-region. When the maximum angle difference is greater than a predetermined angle difference threshold, the processor may determine that the sub-region belongs to an aperture region. In some embodiments, the processor may find all sub-regions corresponding to the aperture region (recorded as reference sub-regions) by traversing each sub-region after division, and determine the data points contained in all reference sub-regions as the point cloud data of the aperture in the data block.

In some other embodiments, the processor may determine the point cloud data of an aperture based on gradient information of the point cloud data and a predetermined gradient distribution rule. More information regarding the gradient information and the predetermined gradient distribution rule may be found in FIG. 4 and related description thereof.

Similar to that the subject has a shape, so that an edge of the subject may be determined by an x-direction gradient and a y-direction gradient of point cloud data, the position of the aperture where the subject is placed may also be determined by the distribution of the x-direction gradient and the y-direction gradient of point cloud data. However, since there is still a certain gap between the aperture and the subject, in the x-direction and γ-direction gradient distributions, the gradient corresponding to the point cloud data is located at the periphery, and the gradient corresponding to the subject is closer to the center. In some other embodiments, the processor may obtain a z-direction gradient distribution of point cloud data. The z-direction gradient of the point cloud data is opposite to the z-direction gradient of the subject, which may be used to distinguish the aperture and the subject.

In 730, the point cloud data of the at least one aperture may be matched with predetermined point cloud data of one or more apertures in a predetermined standard model.

More information about the predetermined standard model and the predetermined point cloud data of the aperture may be found in FIG. 5 and related descriptions thereof.

In some embodiments, the processor may match the point cloud data of an aperture among the at least one aperture with the predetermined point cloud data of the one or more apertures in the predetermined standard model by any feasible point cloud matching manner.

In some embodiments, the processor may extract a local descriptor of the point cloud data of the aperture and a local descriptor of the predetermined point cloud data of an aperture in the predetermined standard model, and perform a pose estimation after finding a corresponding relationship between two matched local descriptors of the point cloud data of the aperture and the predetermined point cloud data of an aperture in the predetermined standard model. For example, the processor may extract the local descriptor of the point cloud data of the aperture or the local descriptor of the predetermined point cloud data of an aperture in the predetermined standard model by key point extraction, local descriptor calculation, etc. The processor may determine the corresponding relationship between the local descriptors of the point cloud data of the aperture and the predetermined point cloud data of an aperture in the predetermined standard model by nearest neighbor search, etc., to determine matched local descriptors. The above description of point cloud matching is for illustrative purposes only and is not intended to limit the scope of the present disclosure.

In some embodiments, for the point cloud data of an aperture, the processor may determine a similarity between the point cloud data and the predetermined point cloud data of each aperture in the predetermined standard model, and designate the predetermined point cloud data of the aperture with a highest similarity with the point cloud data of the aperture as the predetermined point cloud data of the aperture that matches the point cloud data of the aperture. The manner of determining the similarity includes but is not limited to Euclidean distance, cosine similarity, Pearson correlation coefficient, Manhattan distance, etc.

In some embodiments, after matching the point cloud data of the aperture with the predetermined point cloud data one by one, the processor may match a data block associated with the point cloud data of the aperture with the predetermined point cloud data that matches the point cloud data of the aperture to obtain a matching relationship between the point cloud data of the aperture, the data block, and the predetermined point cloud data.

In 740, the anomaly detection of the carrier plate may be performed based on the at least one data block in response to determining that the matching is completed.

In some embodiments, the processor may match the point cloud data of each of the at least one aperture with a corresponding predetermined point cloud data in the predetermined standard model. When the point cloud data of each of the at least one aperture is matched with a corresponding predetermined point cloud data, the processor may determine that the matching is complete.

In some embodiments, in response to determining that the matching is completed, the processor may perform the anomaly detection on the carrier plate in the aforementioned multiple ways based on the at least one data block. More descriptions regarding the anomaly detection may be found in FIGS. 4, 8-13, and relevant descriptions thereof.

In some embodiments of the present disclosure, before performing the anomaly detection, the data block may be matched and positioned based on the point cloud data of the at least one aperture to ensure the accuracy of subsequent detection results.

FIG. 8 is a flowchart illustrating an exemplary process for performing an anomaly detection based on height information according to some embodiments of the present disclosure. In some embodiments, process 800 may be executed by a processor (e.g., the processor 120). For example, the process 800 may be stored in a storage device (e.g., the storage device 130) in the form of a program or instruction, and when the processor executes the program or instruction, the process 800 may be implemented. The operational schematic diagram of the process 800 presented below is illustrative. In some embodiments, the process 800 may be completed using one or more additional operations not described and/or one or more operations not discussed. In addition, an order of operations of process 800 shown in FIG. 8 and described below is not restrictive. As shown in FIG. 8, the process 800 includes the following operations.

In 810, a carrier plate plane may be determined based on point cloud data of a carrier plate.

The point cloud data of the carrier plate refers to point cloud data corresponding to the carrier.

In some embodiments, after matching and positioning each data block with predetermined point cloud data of an aperture in a predetermined standard model, the processor may obtain a position of predetermined point cloud data of the carrier plate in the predetermined standard model, determining data points in the point cloud data corresponding the position of the predetermined point cloud data of the carrier plate in the predetermined standard model, and use the obtained data points as the point cloud data of the carrier plate. In some embodiments, the predetermined standard model may include at least four pieces of predetermined point cloud data of the carrier plate.

The carrier plate plane refers to a plane of the carrier plate that carries a subject.

In some embodiments, the processor may determine the carrier plate plane of the carrier plate based on the point cloud data of the carrier plate. For example, the processor may determine a plane formed by physical points corresponding to each data point in the point cloud data of the carrier plate as the carrier plate plane.

In 820, a maximum height of each of the at least one data block from the carrier plate plane may be obtained.

In some embodiments, for each data block in the at least one data block, the processor may determine the height of each data point in the data block from the carrier plate plane, and determine a maximum height among heights of data points in the data block as the maximum height of the data block from the carrier plate plane. The maximum height of each data block in the at least one data block from the carrier plate plane may be determined. It should be noted that the data block in this embodiment may be a data block divided based on a preset gradient distribution rule.

In 830, the processor 120 may determine that an anomaly involves in a data block corresponding to the maximum height in response to determining that the maximum height of the data block is greater than a first threshold.

In some embodiments, the first threshold may be a threshold value related to the height of the data block from the carrier plate plane. In some embodiments, the first threshold may be a system default value, an empirical value, a manually predetermined value, or any combination thereof, which may be set according to actual needs and is not limited by the present disclosure.

In some embodiments, the first threshold may be positively correlated with the height of the subject. For example, the higher the subject, the larger the first threshold. The height of the subject may be a distance between a highest point of the subject and the carrier plate plane.

In some embodiments of the present disclosure, the first threshold is adjusted according to the height of the subject, so that the actual height of the subject may be taken into consideration to improve the accuracy of anomaly detection.

In some embodiments, when the maximum height of a data block from the carrier plate plane is greater than the first threshold, the processor may determine that an anomaly exists in the data block corresponding to the maximum height.

In some other embodiments, the first threshold may be a threshold related to a height difference. In this case, the processor may determine a difference between the maximum height of the data block from the carrier plate plane and the height of the carrier plate plane to obtain the height difference, and in response to determining that the height difference is greater than the first threshold, determine that the data block corresponding to the maximum height is abnormal.

In some embodiments of the present disclosure, when a maximum height of a data block from the carrier plate plane is greater than the first threshold, the processor may determine that the data block is abnormal, which may effectively screen out excessively high subjects and determine that positions thereof are abnormal.

FIG. 9 is a flowchart illustrating another exemplary process for performing an anomaly detection based on height information according to some embodiments of the present disclosure. In some embodiments, process 900 may be executed by a processor (e.g., the processor 120). For example, the process 900 may be stored in a storage device (e.g., the storage device 130) in the form of a program or instruction, and when the processor executes the program or instruction, the process 900 may be implemented. The operational schematic diagram of the process 900 presented below is illustrative. In some embodiments, the process 900 may be completed using one or more additional operations not described and/or one or more operations not discussed. In addition, an order of operations of the process 900 shown in FIG. 9 and described below is not restrictive. As shown in FIG. 9, the process 900 includes the following operations.

In some embodiments, the processor may perform operations 910-940 on each of the at least one data block to perform an anomaly detection on the carrier plate. It should be noted that the data block used by the processor when performing operations 910-940 may be a data block divided according to a position distribution of the subject on the carrier plate.

In 910, at least one adjacent aperture may be determined based on a current aperture corresponding to a data block.

The current aperture corresponding to a data block refers to an aperture where the data block is located. The adjacent aperture refers to an aperture adjacent to the current aperture.

In some embodiments, the processor may determine one or more apertures adjacent to the current aperture as adjacent apertures.

In 920, first heights of a plurality of first reference regions of the current aperture, and second heights of a plurality of second reference regions of each of the at least one adjacent aperture may be obtained.

A first reference region refers to a designated region within a position region occupied by the current aperture. In some embodiments, the first reference region may include a raised area in a surface of the subject in the current aperture, a central area of the current aperture, or the like.

In some embodiments, the first height of a first reference region may be an average value of heights of the plurality of data points included in the first reference region. In some embodiments, the first height of a first reference region may be a maximum value of the heights of the plurality of data points included in the first reference region. In some embodiments, the first height of a first reference region may be a minimum value of the heights of the plurality of data points included in the first reference region. In some embodiments, the first height of a first reference region may be a mode value of the heights of the plurality of data points included in the first reference region. The height of a data point may be equal to a z-axis coordinate value of the data point.

In some embodiments, the processor may perform a statistical analysis on the heights of the plurality of data points included in the first reference region to obtain the first height of the first reference region.

The second reference region of an adjacent aperture refers to a designated region within the position region occupied by the adjacent aperture. In some embodiments, the second reference region of an adjacent aperture may include a raised area in a surface of the subject set in the adjacent aperture, a central area of the adjacent aperture, or the like.

In some embodiments, the second height of a second reference region may be an average value of the heights of the plurality of data points included in the second reference region. In some embodiments, the second height of a second reference region may be a maximum value of the heights of the plurality of data points included in the second reference region. In some embodiments, the second height of a second reference region may be a minimum value of the heights of the plurality of data points included in the second reference region. In some embodiments, the second height of a second reference region may be a mode value of the heights of the plurality of data points included in the second reference region.

In some embodiments, the processor may perform a statistical analysis on the heights of the plurality of data points included in the second reference region to obtain the second height of the second reference region.

In 930, a height difference sequence may be determined based on the first heights and the second heights.

The height difference sequence refers to a sequence consisting of absolutes of the height differences between the first heights and the second heights. The height differences between the first heights and the second heights may include a height difference between a first height of any first reference region among the plurality of first reference regions and a second height of any second reference region among the plurality of second reference regions.

In some embodiments, for each of the plurality of first reference regions and each of the plurality of second reference regions, the processor may determine an absolute of a height difference between a first height of any first reference region and a second height of any second reference region to obtain the height difference sequence.

It should be noted that when determining the height differences, the first reference region and the second reference region are in different apertures, but the region types are the same. For example, when determining a height difference between a first height of a first reference region A and a second height of a second reference region B, the first reference region A belongs to the current aperture, and the second reference region B belongs to the adjacent aperture, but the first reference region A and the second reference region B are both the raised areas in the surface of the subject in the apertures or both the central areas of the apertures.

In 940, the processor may determine that the carrier plate involves an anomaly in response to determining that a predetermined number of absolutes of height differences is greater than a second threshold.

In some embodiments, the predetermined number may be a system default value, an experience value, a manually predetermined value, or any combination thereof, which may be set according to actual needs and is not limited by the present disclosure.

In some embodiments, the predetermined number may be one, and the processor may determine that the carrier plate involves an anomaly in response to determining that the absolute of the height difference is greater than the second threshold.

In some embodiments, the predetermined number may be two or more, and the processor may determine that the carrier plate involves an anomaly in response to absolutes of two or more height differences s greater than the second threshold in the height difference sequence.

The second threshold refers to a threshold related to the absolute of the height difference value. In some embodiments, the second threshold may be a system default value, an empirical value, a manually predetermined value, etc., or any combination thereof, which may be set according to actual needs and is not limited by the present disclosure.

It should be noted that the anomaly type determined in the above embodiment may be an empty piece anomaly.

When the absolute of the height difference between the first height and the second height is greater than the predetermined second threshold, it indicates that one of the two apertures has no subject placed therein, and the carrier plate may have an empty piece anomaly. In some embodiments of the present disclosure, by comparing the height difference between the first height of the first reference region and the second height of the second reference region with the second threshold, it may be accurately determined whether the carrier has an empty piece anomaly.

FIG. 10 is a flowchart illustrating an exemplary process for performing an anomaly detection based on volume information according to some embodiments of the present disclosure. In some embodiments, process 1000 may be executed by a processor (e.g., the processor 120). For example, the process 1000 may be stored in a storage device (e.g., the storage device 130) in the form of a program or instruction, and when the processor executes the program or instruction, the process 1000 may be implemented. The operational schematic diagram of the process 1000 presented below is illustrative. In some embodiments, the process 1000 may be completed using one or more additional operations not described and/or one or more operations not discussed. In addition, an order of operations of process 1000 shown in FIG. 10 and described below is not restrictive. As shown in FIG. 10, the process 1000 includes the following operations.

In some embodiments, the processor may perform operations 1010-1040 on each of the at least one data block to perform an anomaly detection on the carrier plate. It should be noted that the data block used by the processor when performing operations 1010-1040 may be a data block divided according to a preset gradient distribution rule.

In 1010, point cloud data of a subject may be obtained by cropping a data block.

The point cloud data of a subject refers to point cloud data corresponding to the subject. The point cloud data of a subject may also be referred to be as subject point cloud data.

In some embodiments, the processor may crop out point cloud data of a carrier plate and point cloud data of an aperture from the data block to obtain the point cloud data of the subject.

In some embodiments, the processor may crop the data block according to a predetermined height. The predetermined height may be a height of the carrier plate plane. In some embodiments, the processor may crop out point cloud data of a portion of the data block above the carrier plate plane to obtain the point cloud data of the subject. In some embodiments, the processor may also crop the data block according to a gradient distribution rule to crop out the point cloud data of the entire subject.

In 1020, a gradient feature of the point cloud data of the subject in a target direction may be obtained.

The gradient feature of the point cloud data of the subject in the target direction refers to a feature related to the gradient distribution of the data points in the point cloud data of the subject in the target direction. For example, the gradient feature may include z-direction gradient distribution information of the point cloud data of the subject. More information regarding the target direction may be found in FIG. 6 and related description thereof.

In some embodiments, after obtaining the point cloud data of the subject, the processor may determine the gradient feature of the point cloud data of the subject in the target direction based on a gradient calculation algorithm, for example, using a surface normal calculation function built into MATLAB to determine a point cloud gradient.

In some embodiments, after obtaining the gradient feature of the point cloud data of the subject in the target direction, the processor may perform a morphological processing on the gradient feature to remove local feature interference and enhance a high gradient feature.

In 1030, in response to determining that the gradient feature of the point cloud data of the subject in the target direction is greater than a third threshold, a point cloud volume corresponding to the point cloud data of the subject may be determined using a spatial bounding box algorithm.

The third threshold refers to a threshold related to the gradient feature. In some embodiments, the third threshold may be a system default value, an empirical value, a manually predetermined value, or any combination thereof, which may be set according to actual needs and is not limited by the present disclosure.

In some embodiments, the third threshold is positively correlated to an edge complexity level of the subject in the target direction. For example, the greater the edge complexity level of the subject in the target direction, the greater the third threshold.

In some embodiments, the processor may determine the third threshold by querying a predetermined query table based on the edge complexity level of the subject in the target direction. The predetermined query table may be predetermined based on historical data or prior knowledge. The predetermined query table may include different edge complexities and different third thresholds corresponding to the different edge complexities.

The edge complexity level may be used to describe the complexity of the concave and convex areas of an edge region of the subject. For example, the more convex areas and/or concave areas there are in the edge region of the subject, the higher the edge complexity level of the edge region of the subject.

In some embodiments, the edge complexity level of the subject in the target direction may be determined based on the convex areas and/or concave areas of the edge region of the subject in the target direction. For example, the processor may determine the edge complexity level of the subject in the target direction based on a first count of convex areas and/or the second count of concave areas of the edge region of the subject in the target direction. Merely by way of example, the processor may determine a sum of the first count of convex areas of the edge region of the subject in the target direction and the second count of concave areas of the edge region of the subject in the target direction as the edge complexity level of the subject in the target direction.

In some embodiments of the present disclosure, by considering the edge complexity level of the edge region of the subject, when the edge of the subject is more complex, the z-direction gradient of the edge is larger. At this time, the third threshold is appropriately increased, which may improve the accuracy of foreign object judgment.

The spatial bounding box algorithm refers to an algorithm for solving an optimal bounding space of a discrete point set. The basic idea is to use a slightly larger geometric body (called a bounding box) with simpler features to approximately replace a complex geometric object. Exemplary bounding box algorithms may include an axis-aligned bounding box (AABB) algorithm, a sphere algorithm, an oriented bounding box (OBB) algorithm, and a fixed directions hull (FDH or k-DOP) algorithm.

In some embodiments, the processor may use the spatial bounding box algorithm to determine the point cloud volume corresponding to the point cloud data of the subject whose gradient feature in the target direction is greater than the third threshold. For example, the processor may use the spatial bounding box algorithm to determine the point cloud volume of corresponding to the point cloud data of the subject whose z-direction gradient value is greater than the third threshold.

The above description of determining the point cloud volume is for illustrative purposes only and is not intended to limit the scope of the present disclosure.

In 1040, the processor may determine that the subject corresponding to the point cloud data of the subject involves an anomaly in response to determining that the point cloud volume is greater than a fourth threshold.

The fourth threshold refers to a threshold related to the point cloud volume. In some embodiments, the fourth threshold may be a system default value, an empirical value, a manually predetermined value, or any combination thereof, which may be set according to actual needs and is not limited by the present disclosure.

When the point cloud volume is greater than the predetermined fourth threshold, it indicates that there is a large attachment on the surface of the subject, and it is determined that the subject is abnormal (for example, the abnormal type may be the presence of foreign object). In some embodiments of the present disclosure, for the point cloud data of the subject whose gradient feature in the target direction is greater than the third threshold, according to the comparison of the point cloud volume of the point cloud data of the subject with the fourth threshold, it may be accurately determined whether there is a foreign object anomaly on the subject.

FIG. 11 is a schematic diagram illustrating an exemplary process for performing an anomaly detection based on a first detection model according to some embodiments of the present disclosure.

In some embodiments, as shown in FIG. 11, a processor may determine a first result 1150 by a first detection model 1140 based on at least a portion of at least one data block 1110, a predetermined standard model 1120, and shape information 1130 of a subject. More descriptions regarding the data block may be found in FIG. 4 and related descriptions thereof, and more descriptions of the predetermined standard model may be found in FIG. 5 and related descriptions thereof.

The first detection model refers to a model for detecting whether the data block is abnormal. In some embodiments, the first detection model is a machine learning model. For example, the first detection model may include any one or a combination of various feasible models such as a convolutional neural network (CNN) model and a support vector machine (SVM).

In some embodiments, as shown in FIG. 11, an input of the first detection model 1140 may include the data block 1110, the predetermined standard model 1120, and the shape information 1130 of the subject, and an output may include the first result 1150.

In some embodiments, the input of the first detection model may include one data block, and the output of the first detection model 1140 may be a first result corresponding to the data block.

In other embodiments, the input of the first detection model may include a plurality of data blocks, and the output of the first detection model 1140 may be a first result corresponding to each of the plurality of data blocks.

The shape information refers to information related to a shape of the subject. In some embodiments, the shape information may include a shape type (e.g., cuboid, cube, etc.), a size, etc., of the subject. In some embodiments, the shape information may include a three-dimensional model of the subject. In some embodiments, the shape information may be obtained by user input or by detection using an imaging device.

The first result may indicate whether there is a hitching anomaly in the subject.

In some embodiments, the first result may include that the data block involves a hitching anomaly or that the data block does not involve the hitching anomaly. The hitching anomaly means that the subject is not completely placed in a corresponding fixed position (e.g., the aperture), and a portion of the subject is placed outside the fixed position (e.g., the aperture).

In some embodiments, when the input of the first detection model includes at least one data block, the first detection model may output the first result of whether the at least one data block involves a hitching anomaly.

In some embodiments, the processor may perform a training based on a plurality of first training samples with first labels by various manners to update model parameters and obtain a trained first detection model. For example, the training may be performed based on a gradient descent manner. Merely by way of example, the plurality of first training samples with the first labels may be input into an initial first detection model, a loss function may be constructed by the first labels and results of the initial first detection model, and the parameters of the initial first detection model may be iteratively updated based on the loss function. When a termination condition is satisfied, the model training is completed, and the trained first detection model is obtained. The termination condition may be that the loss function converges, a count of iterations reaches a threshold, etc.

In some embodiments, the first training samples may include a sample data block, a predetermined standard model of a sample carrier plate, and shape information of a sample subject, and the first label may be a first result corresponding to the sample data block.

In some embodiments, a historical data block, a predetermined standard model of a historical carrier plate, and shape information of a historical subject in a large amount of historical detection data may be used as the first training sample, and a historical result of whether the historical data block involves a hitching anomaly may be marked as the first label. For example, when the historical carrier plate involves a hitching anomaly, the first label may be marked as 1. Otherwise, the first label may be marked as 0.

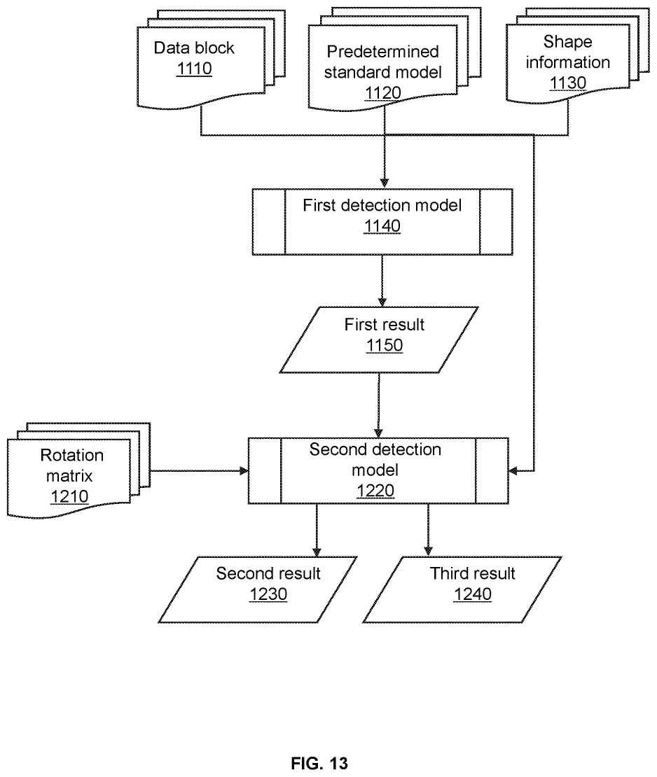

In some other embodiments, the first detection model may be obtained by joint training with the second detection model. For the training process of the joint training, please refer to the relevant content of FIG. 13.

In some embodiments of the present disclosure, the first detection model is used to determine whether the subject has a hitching anomaly based on the data block, the predetermined standard model, and the shape information of the subject. The first detection model may be used to improve data processing efficiency and accuracy, thereby quickly and efficiently determining whether the subject has the hitching anomaly, which is conducive to realizing the intelligence and automation of a system for anomaly detection.

FIG. 12 a schematic diagram illustrating an exemplary process for performing an anomaly detection based on a second detection model according to some embodiments of the present disclosure.

In some embodiments, as shown in FIG. 12, a processor may determine at least one of a second result 1230 and a third result 1240 by a second detection model 1220 based on the at least one data block 1110, the predetermined standard model 1120, the shape information 1130 of the subject, and a rotation matrix 1210 corresponding to the data block. More descriptions regarding the data block may be found in FIG. 4 and relevant descriptions thereof, and more descriptions of the predetermined standard model may be found in FIG. 5 and relevant descriptions thereof. More descriptions regarding the rotation matrix may be found in FIG. 6 and relevant descriptions thereof, and more descriptions of the shape information may be found in FIG. 11 and relevant descriptions thereof.

The second detection model is a model for determining whether there is an empty piece or a foreign object involves in the data block. In some embodiments, the second detection model is a machine learning model. For example, the second detection model may include any one or combination of a deep neural network (DNN) model, a convolutional neural network (CNN) model, a neural network (NN) model, or other custom model structures.

In some embodiments, as shown in FIG. 12, an input of the second detection model 1220 may include the data block 1110, the predetermined standard model 1120, the shape information 1130 of the subject, and the rotation matrix 1210 corresponding to the data block 1110, and an output may include one of the second result 1230 and the third result 1240.

In some embodiments, the data block input into the second detection model may include all data blocks corresponding to the carrier plate and the subject, the rotation matrix input into the second detection model may include rotation matrices corresponding to all data blocks, and the output of the second model may be the second result and/or the third result corresponding to the carrier plate.

The second result may indicate whether there is an empty piece anomaly on the carrier plate. In some embodiments, the second result includes whether the carrier plate involves an empty piece and a corresponding empty piece parameter if the carrier plate involves an empty piece.

An empty piece refers to an aperture on the carrier plate where no subject is placed. The empty piece parameter refers to a parameter related to the empty piece. In some embodiments, the empty piece parameter may include positions and a count of empty pieces on the carrier plate.

The third result may indicate whether the carrier plate involves a foreign object. In some embodiments, the third result may include whether the carrier plate involves a foreign object and the foreign object parameter if the carrier plate involves a foreign object.

The foreign object refers to a substance other than the subject placed on the carrier plate that interferes with the detection. The foreign object parameter refers to a parameter related to the foreign object appearing on the carrier plate. In some embodiments, the foreign object parameter may include a position of the foreign object appearing on the carrier plate, a type of the foreign object, etc.

In some embodiments, the processor may perform a training based on a plurality of second training samples with second labels by various manners to update model parameters and obtain a trained second detection model. For example, the training may be performed based on a gradient descent manner. The specific process of training the second detection model is similar to the specific process of training the first detection model mentioned above, and will not be repeated here.

In some embodiments, the second training sample may include all sample data blocks of a sample carrier plate and a sample subject, a predetermined standard model of the sample carrier plate, shape information of the sample subject, and a sample rotation matrix corresponding to the sample data block, and the second label may include a second result and/or a third result corresponding to the sample carrier plate.

In some embodiments, a historical data block of a historical carrier plate and a historical subject, a predetermined standard model of the historical carrier plate, shape information of the historical subject, and a historical rotation matrix corresponding to historical data block in a large amount of historical detection data may be used as the second training samples, and a historical result of whether the historical carrier plate has an empty piece anomaly and/or a foreign object are marked as the second label. For example, when the historical carrier plate involves the empty piece anomaly and/or the foreign object, the second label may be marked as 1. When the historical carrier plate does not involve the empty piece anomaly or no foreign object is present, the second label may be marked as 0.

In some embodiments, the second label includes a first sub-label and a second sub-label. For example, when an empty piece anomaly occurs on the historical carrier plate, the first sub-label may be marked as 1; otherwise, the first sub-label may be marked as 0. When a foreign object occurs on the historical carrier plate, the second sub-label may be marked as 1; otherwise, the second sub-label may be marked as 0. That is, when an empty piece anomaly and a foreign object occur on the historical carrier plate, the second label is marked as (1, 1). When an empty piece anomaly occurs on the historical carrier plate but no foreign object occurs, the second label is marked as (1, 0). When an empty piece anomaly does not occur on the historical carrier plate but a foreign object occurs, the second label is marked as (0, 1). When no empty piece anomaly and no foreign object occur on the historical carrier plate, the second label is marked as (0, 0).

In some other embodiments, the second detection model may be obtained by joint training with the first detection model. For the training process of the joint training, please refer to FIG. 13 and related descriptions thereof.

In some embodiments of the present disclosure, the second detection model is used to perform the anomaly detection on the subject, which may effectively evaluate whether there are abnormal conditions such as empty pieces or foreign objects on the carrier plate, and may intelligently detect abnormal conditions to avoid interference with subsequent processing processes, thereby improving the efficiency of abnormal condition judgment. In addition, since the scanning plane of the imaging device that obtains the point cloud data is not necessarily completely parallel to the carrier plate plane, there will be errors in anomaly judgment. Inputting the rotation matrix corresponding to the data block into the second detection model may make the model prediction more accurate.

FIG. 13 a schematic diagram illustrating an exemplary process for performing an anomaly detection based on based on a first detection model and a second detection model according to some embodiments of the present disclosure.

In some embodiments, as shown in FIG. 13, the processor may determine the first result 1150 through the first detection model 1140 based on the data block 1110, the predetermined standard model 1120, and the shape information 1130 of the subject. In some embodiments, the processor may determine at least one of the second result 1230 and the third result 1240 through the second detection model 1220 based on the data block 1110, the predetermined standard model 1120, the shape information 1130 of the subject, the rotation matrix 1210 corresponding to the data block 1110, and the first result 1150. More descriptions regarding the data block may be found in FIG. 4 and relevant descriptions thereof, and more descriptions regarding the predetermined standard model may be found in FIG. 5 and relevant descriptions thereof. More descriptions of the rotation matrix may be found in FIG. 6 and relevant descriptions thereof. More descriptions regarding the first detection model, the first result, and the shape information may be found in FIG. 11 and relevant descriptions thereof. More descriptions regarding the second detection model, the second result, and the third result may be found in FIG. 12 and relevant descriptions thereof.

In some embodiments, the input of the first detection model may include one data block, and the output of the first detection model may be a first result corresponding to the data block.

In other embodiments, the input of the first detection model may include a plurality of data blocks, and the output of the first detection model may be a first result corresponding to each of the plurality of data blocks.

In some embodiments, the data block input into the second detection model may include all data blocks corresponding to the carrier plate and the subject, the rotation matrix input into the second detection model may include rotation matrices corresponding to all data blocks, and the output of the second model may be the second result and/or the third result corresponding to the carrier plate.

In some embodiments, the output of the first detection model may be input into the second detection model. For example, all first results of the first detection model on all data blocks in the at least one data block may be input into the second detection model.

In some embodiments, the first detection model and the second detection model may be obtained by jointly training. In some embodiments, training samples of the joint training may include sample data blocks of a sample carrier plate and a sample subject, a predetermined standard model of the sample carrier plate, shape information of the sample subject, and a sample rotation matrix corresponding to the sample data block, and training labels of the joint training may be the second result and/or the third result corresponding to the sample carrier plate.

In some embodiments, the joint training may include: inputting the sample data blocks of the sample carrier plate and the sample subject, the predetermined standard model of the sample carrier plate, the shape information of the sample subject into an initial first detection model to obtain the first results; inputting the first results corresponding to the sample data blocks in the at least one sample data block corresponding to the sample carrier plate and the sample subject, the sample data blocks in the at least one sample data block, the sample predetermined standard model, the shape information of the sample subject, and the sample rotation matrix into an initial second detection model to obtain the second results and/or the third results; constructing a loss function based on the second results and/or the third results output by the initial second detection model and the training labels of the joint training, and iteratively updating model parameters of the initial first detection model and the initial second detection model based on the loss function, respectively, until a termination condition is met and the training is completed. The termination condition may be that the loss function converges, a count of training times reaches a threshold, etc.

In some embodiments of the present disclosure, by inputting the first result output by the first detection model after performing an abnormal judgment on all data blocks into the second detection model, the abnormal detection process may be further improved, making the abnormal detection result more complete and accurate, thereby improving the detection accuracy of the substrate detection system and improving the yield rate of the product.

A specific embodiment is given below to further fully and in detail illustrate the method for anomaly detection of a carrier plate implemented in the present disclosure.

In operation 1, 3D point cloud data of the carrier plate and a subject may be obtained. Based on a neighborhood distance distribution of each data point in the point cloud according to a statistical mathematical model, a mean and a standard deviation may be determined, a normal distribution diagram may be constructed, and a predetermined interval may be determined, so that distances of all data points are within the predetermined, and the point cloud data after stray point filtering may be obtained.

In operation 2, based on a gradient distribution rule of an x-direction gradient and a y-direction gradient of the point cloud data, the relative position relationship between subject may be determined, the complete point cloud data may be divided into blocks, and a multi-threaded concurrent technology may be used to accelerate a processing of dividing the point cloud data.

In operation 3, based on point cloud spatial distribution information of the divided point cloud data, a data matrix may be obtained, and a covariance matrix may be determined. A minimum eigenvalue and a minimum eigenvector corresponding to the data matrix may be obtained using the covariance matrix, a rotation matrix (0, 0, 1) from the minimum eigenvector to a positive unit vector of the z-axis may be determined, and the entire data block may be rotated based on the rotation matrix to achieve leveling of the entire data block, and a corrected data block may be obtained.

In operation 4, point cloud data of at least one aperture may be determined based on normal features of the point cloud data; the point cloud data of the at least one aperture may be matched with predetermined point cloud data of the aperture in a predetermined standard model, the at least one aperture may be matched and positioned to obtain spatial position information of the aperture. The process for obtaining the normal features includes: finding a preset count of neighboring points of a target point, filtering outliers far from a center point, fitting the filtered neighboring points with a quadratic surface, and determining a normal of the center point. The normal may be used as the normal feature of the target point. Since the normal feature of the aperture edge is irregular and divergent, the point cloud data of at least one aperture may be determined according to a normal distribution rule, and then the at least one aperture may be matched with the aperture in the predetermined standard model.

In operation 5, a single data block may be taken as a processing unit, hitching feature information may be determined and input into a hitching feature model (i.e., the first detection model) to obtain a hitching feature comparison result (i.e., the first result). If the first result is OK, operation 6 may be executed, otherwise, a hitching detection result of the processing unit is NG, detection of the processing unit ends, and the detection result is recorded. The process for determining the hitching feature information, inputting the hitching feature information in to the hitching feature model, and obtaining the hitching feature comparison result may include: after completing the matching and positioning of the data block and the predetermined standard model, determining the carrier plate plane according to the predetermined point cloud data of the carrier plate in the predetermined standard model, and obtaining a maximum height of each data block and the carrier plate plane, which is equivalent to a maximum height of the subject and the carrier plate; wherein when the maximum height is greater than a first threshold, the hitching detection result of the processing unit is judged as NG, otherwise the first result is judged as OK.

In operation 6, empty piece feature information may be determined and input into the empty piece feature model (i.e., the second detection model), and an empty piece feature comparison result (i.e., the second result) may be obtained. If the second result is OK, operation 7 may be executed, otherwise, the empty piece detection result of the processing unit is NG, the detection of the processing unit ends, and the detection result is recorded. The process for determining the empty piece feature information, inputting the empty piece feature information into the empty piece feature model, and obtaining the empty piece feature comparison result may include: obtaining a first height of a first reference region of a current aperture and a second height of a second reference region of an adjacent aperture, wherein when an absolute of a height difference between the first height and the second height is greater than a second threshold, the empty piece detection result of the processing unit is judged as NG, otherwise, the second result is judged as OK.

In operation 7, foreign object feature information may be determined and input into a foreign object feature model (i.e., the second detection model), and a foreign object feature comparison result (i.e., the third result) may be obtained. If the third result is OK, the final detection result of the processing unit is OK, otherwise, the foreign third detection result of the processing unit is NG, the detection of the processing unit ends, and the detection result is recorded. The process for determining the foreign object feature information, inputting the foreign object feature information into the foreign object feature model, and obtaining the foreign object feature comparison result may include: cropping point cloud data of the at least one aperture of a current carrier plate to obtain cropped point cloud data only including the point cloud data of the subject, z-direction point cloud gradient information of the point cloud data of the subject may be determined, and a point cloud gradient field (i.e., a gradient feature of the point cloud data of the subject in the target direction) may be obtained. In the gradient field, a morphological processing may be performed on the point cloud data, local point cloud feature interference may be removed, and high gradient features may be enhanced. Point cloud information with a gradient value greater than the third threshold in the gradient field may be screened, its spatial bounding box algorithm and point cloud volume may be determined, and if the point cloud volume is greater than the fourth threshold, it is judged as NG, otherwise, it is judged as OK.

In operation 8: detection results of all data blocks may be counted.

In summary, in some embodiments of the present disclosure, by obtaining 3D point cloud data of a carrier plate and a subject, dividing the 3D point cloud into blocks according to the gradient distribution rule of the x-direction gradient and the y-direction gradient of the point cloud in the 3D point cloud data in the world coordinate system, and then using the height information contained in the 3D point cloud to determine the position of the data block, whether there is any positional abnormality in the subject may be detected, thereby avoiding damage to the subsequent process quality and reducing the product defect rate.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

1. A method for anomaly detection of a carrier plate, implemented by a system for anomaly detection of a carrier plate including at least a processor and a storage device comprising:
obtaining point cloud data of the carrier plate and a subject placed on the carrier plate;
obtaining at least one data block by segmenting the point cloud data; and
performing an anomaly detection of the carrier plate based on the at least one data block.

2. The method of claim 1, wherein obtaining the point cloud data includes:
obtaining initial point cloud data; and
obtaining the point cloud data by pre-processing the initial point cloud data.

3. The method of claim 2, wherein pre-processing the initial point cloud data includes:
for a target point in the initial point cloud data,
determining a distance between the target point and other points in the initial point cloud data;
determining at least one first reference point based on the distance between the target point and the other points;
determining an average distance between the target point and the at least one first reference point; and
rejecting the target point from the initial point cloud data in response to determining that the average distance corresponding to the target point satisfies a condition.

4. The method of claim 3, wherein the condition comprises the average distance being less than a first distance threshold or the average distance being greater than a second distance threshold, the first distance threshold being less than the second distance threshold, the first distance threshold is determined based on remaining computational resources of the carrier plate detection system.

5. (canceled)

6. The method of claim 4, wherein the second distance threshold is determined according to operations including:
determining, for each of a plurality of predetermined points in a predetermined standard model, an average distance between the predetermined point and remaining predetermined points in the predetermined standard model; and
determining the second distance threshold based on average distances corresponding to the plurality of predetermined points.

7. The method of claim 1, wherein segmenting the point cloud data includes:
segmenting the point cloud data based on gradient information of the point cloud data and a gradient distribution rule.

8. The method of claim 1, wherein performing an anomaly detection of the carrier plate based on the at least one data block includes:
obtaining at least one corrected data block by correcting the at least one data block; and
determining whether the carrier plate involves an anomaly based on the at least one corrected data block.

9. The method of claim 8, wherein the method further comprises:
determining whether to correct the at least one data block based on height information of the at least one data block in a target direction.

10. The method of claim 8, wherein obtaining at least one corrected data block by correcting the at least one data block includes:
for one of the at least one data block,
obtaining a data matrix of the data block;
obtaining a covariance matrix based on the data matrix;
determining a minimum eigenvector corresponding to a minimum eigenvalue based on the covariance matrix;
determining a unit vector in the target direction based on the height information of the data block in the target direction;
obtaining a rotation matrix based on the minimum eigenvector and the unit vector; and
obtaining a corrected data block by rotating the data block based on the rotation matrix.

11. The method of claim 1, wherein the carrier plate is provided with at least one aperture, one of the at least one aperture having the subject placed therein, and performing an anomaly detection of the carrier plate based on the at least one data block includes:
obtaining normal features of the point cloud data;
determining point cloud data of the at least one aperture based on the normal features of the point cloud data;
matching the point cloud data of the at least one aperture with predetermined point cloud data of an aperture in a predetermined standard model; and
performing the anomaly detection of the carrier plate based on the at least one data block in response to determining that the matching is completed.

12. The method of claim 11, wherein the normal features of the point cloud data comprise a normal feature of each target point in the point cloud data, and obtaining the normal features of the point cloud data includes:
for each target point in the point cloud data,
determining a distance between the target point and each of other points in the initial point cloud data;
determining at least one second reference point based on the distance between the target point and each of other points in the initial point cloud data;
obtaining a fitting surface by fitting the at least one second reference point; and
designating a normal feature of a center point of the fitting surface as the normal feature of the target point.

13. The method of claim 1, wherein performing an anomaly detection of the carrier plate based on the at least one data block of the point cloud data includes:
determining a carrier plate plane based on point cloud data of the carrier plate, the point cloud data of the carrier plate being determined based on pre-determined point cloud data of the carrier plate in a pre-determined standard model;
obtaining a maximum height among at least one height each of which is of one of the at least one data block of point cloud data from the carrier plate plane; and
determining that an anomaly involves in a data block whose maximum height from the carrier plate plane is greater than a first threshold, wherein the first threshold is positively correlated to a height of the subject.

14. (canceled)

15. The method of claim 1, wherein the carrier plate is provided with at least one aperture, at least a portion of the at least one aperture having subjects placed therein, and performing an anomaly detection of the carrier plate based on the at least one data block of the point cloud data includes:
for each of the at least one data block,
determining at least one adjacent aperture based on a current aperture corresponding to the data block;
obtaining first heights of a plurality of first reference regions of the current aperture, and second heights of a plurality of second reference regions of each of the at least one adjacent aperture, the first reference regions and the second reference regions comprising a raised area in a surface of the subjects;
determining height differences based on the first heights and the second heights; and
determining that the carrier plate involves an anomaly in response to determining that a predetermined number of absolutes of height differences among the height differences based on the first heights and the second heights is greater than a second threshold.

16. The method of claim 1, wherein performing an anomaly detection of the carrier plate based on the at least one data block of the point cloud data includes:
for each of the at least one data block,
obtaining point cloud data of the subject by cropping the data block;
obtaining a gradient feature of the point cloud data of the subject in a target direction;
determining, in response to determining that the gradient feature of the point cloud data of the subject in the target direction is greater than a third threshold, a point cloud volume corresponding to the point cloud data of the subject using a spatial enveloping box; and
determining that the subject corresponding to the point cloud data of the subject involves an anomaly in response to determining that the point cloud volume is greater than a fourth threshold.

17. The method of claim 16, wherein the third threshold is positively correlated to an edge complexity level of the subject in the target direction, the edge complexity level in the target direction being determined based on a raised area and/or a recessed area of an edge region of the subject in the target direction.

18. The method of claim 1, wherein performing an anomaly detection of the carrier plate based on the at least one data block of the point cloud data includes:
determining a first result by a first detection model based on at least a portion of the at least one data block, a predetermined standard model, and shape information of the subject; wherein the first result indicates whether the data block involves a hitching anomaly, and the first detection model is a trained machine learning model.

19. The method of claim 1, wherein performing an anomaly detection of the carrier plate based on the at least one data block of point cloud data includes:
determining at least one of a second result and a third result by a second detection model based on the at least one data block, a predetermined criterion model, shape information of the subject, and at least one rotation matrix corresponding to the at least one data block; wherein the second result indicates whether an empty piece involves in the carrier plate and an empty piece parameter, the third result includes whether a foreign object involves in the carrier plate and a foreign object parameter, and the second detection model is a trained machine learning model.

20. The method of claim 1, wherein performing an anomaly detection of the carrier plate based on the at least one data block of point cloud data includes:
determining a first result by a first detection model based on at least a portion of the at least one data block, a predetermined standard model, and shape information of the subject; wherein the first result indicates whether the data block involves a hitching anomaly, and the first detection model is a trained machine learning model; and
determining at least one of a second result and a third result by a second detection model based on the at least one data block, a predetermined criterion model, shape information of the subject, at least one rotation matrix corresponding to the at least one data block, and the first result; wherein the second result indicates whether an empty piece involves in the carrier plate and an empty piece parameter, the third result includes whether a foreign object involves in the carrier plate and a foreign object parameter, the second detection model is a machine learning model, and the first detection model and the second detection model are obtained by joint training.

21. A system for anomaly detection of a carrier plate, wherein a subject is placed on the carrier plate, comprising:
at least one storage device including a set of instructions; and
at least one processor in communication with the at least one storage device, wherein when executing the set of instructions, the at least one processor is directed to perform operations including:
obtaining point cloud data of the carrier plate and a subject placed on the carrier plate;
obtaining at least one data block by segmenting the point cloud data; and
performing an anomaly detection of the carrier plate based on the at least one data block.

22-41. (canceled)

42. A non-transitory computer readable medium, comprising at least one set of instructions, wherein when executed by one or more processors of a computing device, the at least one set of instructions causes the computing device to perform a method for evaluating a blood flow parameter, the method comprising:
obtaining point cloud data of the carrier plate and a subject placed on the carrier plate;
obtaining at least one data block by segmenting the point cloud data; and
performing an anomaly detection of the carrier plate based on the at least one dat.
